(19) United States
(12) Patent Application Publication
(10) Pub. No.: US 2014/0331007 A1
(43) Pub. Date: Nov. 6, 2014

(54) VIRTUAL LIBRARY CONTROLLER AND CONTROL METHOD

(71) Applicant: FUJITSU LIMITED, Kawasaki-shi (JP)

(72) Inventor: Kazuki SASAKI, Kawasaki-shi (JP)

(73) Assignee: FUJITSU LIMITED, Kawasaki-shi (JP)

(21) Appl. No.: 14/259,502

(22) Filed: Apr. 23, 2014

(30) Foreign Application Priority Data
May 2, 2013 (JP) 2013-096754

(51) Int. Cl. G06F 3/06

(52) U.S. Cl. CPC G06F 3/0686; G06F 3/0665; G06F 3/0619
USPC 711/113

(57) ABSTRACT

A virtual library controller includes: a substitution logical volume creation unit to create, in a case that a logical volume subject to an instruction to write data from a superior device is not present in a cache disk, a substitution logical volume in the cache disk; and a write process unit to carry out write of the data in the created substitution logical volume.

### CROSS-REFERENCE TO RELATED APPLICATION

This application is based upon and claims the benefit of priority of the prior Japanese Patent Application No. 2013-096754, filed on May 2, 2013, the entire contents of which are incorporated herein by reference.

### FIELD

The embodiments discussed herein are related to a virtual library controller and a control method.

### BACKGROUND

For applications in data backup and the like in a server system, a virtual tape library (VTL) is used.

A virtual tape library is a system that virtualizes a tape drive device and a cartridge tape on a dedicated disk device. A virtual tape library is provided with, for example, a disk array device and utilizes the disk array device as a cache disk. Then, the library is provided with a mechanism that virtualizes a tape volume to emulate the tape volume on the cache disk described above.

The virtualized tape (virtual tape, logical volume) is recognized as a tape device from an operating system (OS) of a server. In the server, it is possible to use the virtual tape similar to a regular tape device, and this enables the server to use a virtual tape library as if an actual tape is mounted there.

In the virtual tape library, as a mechanism to achieve external archive administration by discharging the stored logical volume, there is an export function.

The export function copies a plurality of logical volumes stored in a virtual tape library system to a tape for external archive (physical volumes), thereby enabling the copied physical volumes to be taken out to outside for archive and use.

The physical volume is, for example, a cartridge tape and is provided in an actual library. The actual library is provided with one or more of tape drives (physical drives) to carry out writing and reading of data to a plurality of cartridge tapes. The library is also provided with a robot to deliver an arbitrary cartridge tape out of the plurality of cartridge tapes to a tape drive.

The logical volumes are deleted on the cache disk from those of lower frequency of access from a superior device, such as a host, for example, in order. This causes to create those stored only in a physical volume and not present in a cache disk in a logical volume.

An example of related art is Japanese Laid-open Patent Publication No. 2011-123834.

However, in such a virtual tape library in the past, in a case that a writing request from a host to a logical volume not present in a cache disk is made, a relevant logical volume has to be recalled from an actual library. The recall process is mediated by a mechanical behavior of a robot in the actual library to mount a cartridge tape in which the relevant logical volume is stored to a physical drive, so that there is a problem that it takes time.

In other words, in the actual library, the time period taken until the cartridge tape is mounted to the physical drive impedes writing performances in the virtual tape library.

### SUMMARY

According to an aspect of the invention, a virtual library controller includes: a substitution logical volume creation unit to create, in a case that a logical volume subject to an instruction to write data from a superior device is not present in a cache disk, a substitution logical volume in the cache disk; and a write process unit to carry out write of the data in the created substitution logical volume.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a virtual library system as one example of embodiments;

FIG. 2 illustrates a hardware configuration of a virtual library system as one example of embodiments;

FIG. 3 schematically illustrates a data configuration of a logical volume in a cache disk in a virtual library system as one example of embodiments;

FIG. 4 is a chart exemplifying LV information in a virtual library system as one example of embodiments;

FIG. 5 schematically illustrates a configuration of stub data;

FIG. 6 schematically illustrates a data configuration of a substitution logical volume in a virtual library system as one example of embodiments;

FIG. 7 is a chart exemplifying LV information of a substitution logical volume in a virtual library system as one example of embodiments;

FIGS. 8A through 8C illustrate update of a logical volume by write process in a virtual library system as one example of embodiments;

FIG. 9 illustrates additional write process to a substitution logical volume in a virtual library system as one example of embodiments;

FIG. 10 is a chart exemplifying LV information on a substitution logical volume to which additional write process in a virtual library system as one example of embodiments is carried out;

FIG. 11 illustrates rewrite process to a substitution logical volume in a virtual library system as one example of embodiments;

FIG. 12 is a chart exemplifying LV information on a substitution logical volume to which rewrite process in a virtual library system as one example of embodiments is carried out;

FIG. 13 is a chart exemplifying LV information registered in PV management information in a virtual library system as one example of embodiments;

FIGS. 14A and 14B illustrate migration of additionally written data in a virtual library system as one example of embodiments;

FIG. 15 is a chart exemplifying LV information on a substitution logical volume registered in PV management information in a virtual library system as one example of embodiments;

FIG. 16 is a chart exemplifying LV information of PV management information after synchronized with a substitution logical volume in a virtual library system as one example of embodiments;

FIG. 17 is a chart exemplifying LV information of PV management information after synchronized with a substitution logical volume in a virtual library system as one example of embodiments;

FIG. 18 is a chart exemplifying LV information after synchronized with a substitution logical volume of LV management information in a virtual library system as one example of embodiments;

FIG. 19 is a diagram exemplifying a physical volume in which division migration is carried out in a virtual library system as one example of embodiments;

FIG. 20 is a chart exemplifying LV information of PV management information after reorganization in a virtual library system as one example of embodiments;

FIGS. 21A and 21B illustrate migration of rewritten data in a virtual library system as one example of embodiments;

FIG. 22 is a chart exemplifying LV information on a logical volume registered in PV management information in a virtual library system as one example of embodiments;

FIG. 23 is a chart exemplifying LV information on a substitution logical volume registered in PV management information in a virtual library system as one example of embodiments;

FIG. 24 is a chart exemplifying LV information of PV management information after synchronized with a substitution logical volume in a virtual library system as one example of embodiments;

FIG. 25 is a chart exemplifying LV information of LV management information after synchronized with a substitution logical volume in a virtual library system as one example of embodiments;

FIG. 26 is a flowchart illustrating mounting process in a virtual library system as one example of embodiments;

FIG. 27 is a sequence diagram illustrating mounting process in a virtual library system as one example of embodiments;

FIG. 28 illustrates each process and entities thereof in FIG. 27;

FIG. 29 is a flowchart illustrating additional write process to a substitution logical volume in a virtual library system as one example of embodiments;

FIG. 30 is a sequence diagram illustrating additional write process in a virtual library system as one example of embodiments;

FIG. 31 illustrates each process and entities thereof in FIG. 30;

FIG. 32 is a flowchart illustrating rewrite process to a substitution logical volume in a virtual library system as one example of embodiments;

FIG. 33 is a sequence diagram illustrating additional write process in a virtual library system as one example of embodiments;

FIG. 34 illustrates each process and entities thereof in FIG. 33;

FIG. 35 is a flowchart illustrating migration process in a case of additional writing in a virtual library system as one example of embodiments;

FIG. 36 is a sequence diagram illustrating migration according to additional write process in migration to an identical PV in a virtual library system as one example of embodiments;

FIG. 37 illustrates each process and entities thereof in FIG. 36;

FIG. 38 is a sequence diagram illustrating additional write process in division migration in a virtual library system as one example of embodiments;

FIG. 39 illustrates each process and entities thereof in FIG. 38;

FIG. 40 is a flowchart illustrating migration process in a case of rewriting in a virtual library system as one example of embodiments;

FIG. 41 is a sequence diagram illustrating migration according to rewrite process in a virtual library system as one example of embodiments;

FIG. 42 illustrates each process and entities thereof in FIG. 41;

FIG. 43 is a sequence diagram illustrating read process to a substitution logical volume in a virtual library system as one example of embodiments; and

FIG. 44 illustrates each process and entities thereof in FIG. 43.

### DESCRIPTION OF EMBODIMENTS

Descriptions are given below to embodiments according to the present virtual library controller and the control method with reference to the drawings. It is to be noted that the embodiments described below are merely exemplification and it is not intended to exclude applications of various modifications and techniques that are unspecified in the embodiments. In other words, it is possible to perform the present embodiments by variously modifying (such as combining embodiments and respective modifications) without departing from the spirit thereof. Each drawing is not intended to be provided with illustrated components only, but is possible to include other functions and the like.

(1) Configuration

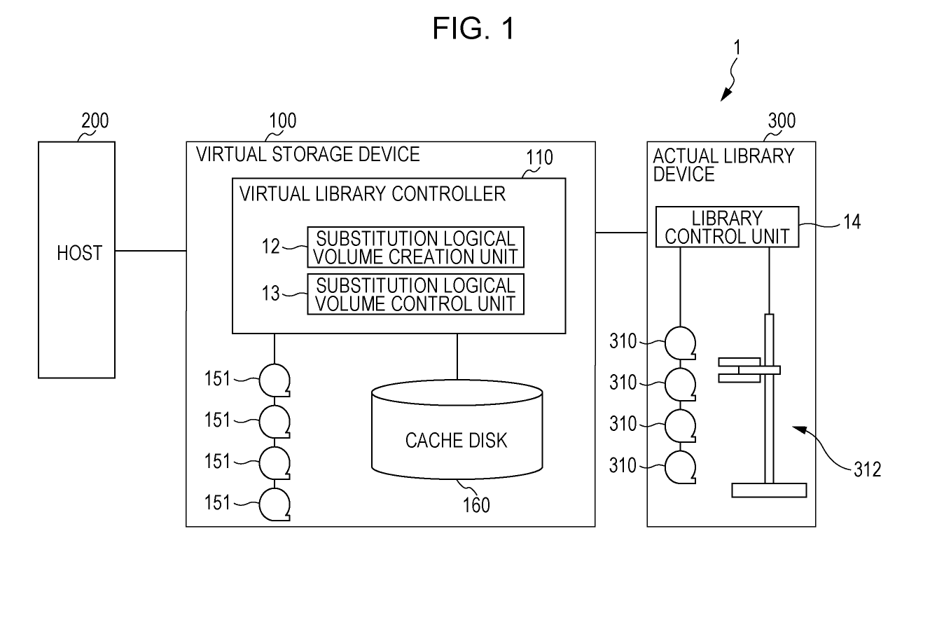

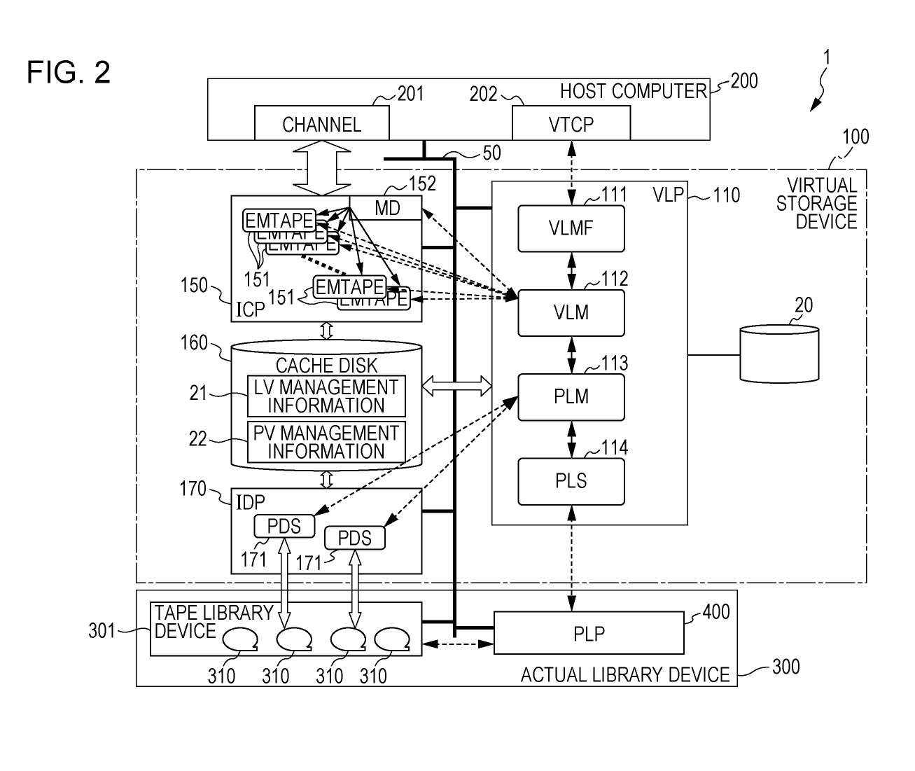

FIG. 1 illustrates a configuration of a virtual library system as one example of embodiments, and FIG. 2 illustrates a hardware configuration thereof.

A present virtual library system 1 is provided with, as illustrated in FIGS. 1 and 2, a host (superior device) 200, a virtual storage device 100, and an actual library device 300.

The virtual library system 1 is provided with a cache disk 160 described later to virtually achieve tape administration in the cache disk 160. In other words, the virtual storage device 100 mediates between the host 200 and the actual library 300 to store data sent and received between the host 200 and the actual library 300 as a virtual tape volume.

The virtual tape library system 1 stores data sent from the host 200 in a tape volume [logical volume (LV)] that is formed virtually in the cache disk 160. For example, as a backup job for data of the host 200, various types of data used in the host 200 is stored in the cache disk 160.

In other words, the virtual library system 1 removes mechanical behaviors, such as tape mounting and load/unload of the actual library device 300, by disposing a virtual tape volume in the cache disk 160 to achieve high speed process.

The virtual library system 1 is provided with a tape library device 301 (refer to FIG. 2), and in the tape library device 301, an LV is written in a cartridge tape, not illustrated, which is an archival medium, via physical drives 310. In the present virtual library system 1, this cartridge tape is equivalent to a physical volume (PV). Hereinafter, a cartridge tape may be referred to as a PV.

The host 200 is an information processing device (computer) that accesses an LV virtualized by the virtual storage device 100 to carry out writing and reading of data. The host 200 is, as illustrated in FIG. 2, communicatively connected to an integrated channel processor (ICP) 150 of the virtual storage device 100 via a channel 201 by an FC and an OCLINK.

The host 200 executes a virtual tape control program (VTCP) 202 by a central processing unit (CPU), not illustrated, thereby issuing a request (read request/write request) to an LV.

The actual library 300 is, as illustrated in FIG. 2, provided with a physical library processor (PLP) 400 and the library device 301.

The library device 301 is provided with one or more tape drives 310 to carry out writing and reading of data to the plurality of cartridge tapes. Hereinafter, the tape drives 310 may be referred to as physical drives 310, and the cartridge tape may be referred to as a physical volume or a PV.

The tape library device 301 is provided with a robot 312 to deliver an arbitrary cartridge tape out of the plurality of cartridge tapes to the tape drives 310. The examples illustrated in FIG. 1 and FIG. 2 illustrate examples that the library device 301 is provided with four tape drives 310, which is not limited to them. In other words, not more than three or not less than five tape drives 310 may also be provided and it is possible to perform a variety of modifications.

The PLP 400 is a server that issues a request to a physical tape library of the library device 301 and is configured with, for example, an IA server. The PLP 400 carries out a request, to the robot 312 of the tape library device 301, to mount a cartridge tape and the like to the tape drive 310. The PLP 400 functions as a library control unit 14 (refer to FIG. 1) that controls the physical drives 310 and the robot 312 in the actual library device 300.

The virtual storage device 100 manages logical drives 151 and the LV to carry out reading and writing of data to the LV that is formed virtually in the cache disk 160. The virtual storage device 100 stores data sent from the host 200 in the LV.

The virtual storage device 100 is provided with, for example, as illustrated in FIG. 2, a virtual library processor (VLP) 110, the ICP 150, the cache disk 160, an integrated drive processor (IDP) 170, and a storage device 20.

The host computer 200, the VLP 110, the ICP 150, the IDP 170, the PLP 400, and the tape library device 301 are connected communicatively to each other via a local area network (LAN) 50. The host computer 200 and the ICP 150 are connected by a fibre channel (FC) or an OCLINK®. In addition, between the ICP 150 and the cache disk 160, between the cache disk 160 and the IDP 170, and between the IDP 170 and each physical drive 310 stored in the tape library device 301 are connected by an FC and the like.

In other words, in the virtual storage device 100, a plurality of processes carry out communication using a pipe or a socket on each server of the ICP 150, the IDP 170, and the VLP 110 to achieve a virtual tape system.

Then, it is possible to configure the ICP 150, the cache disk 160, the IDP 170, the VLP 110, the tape library device 301, and the PLP 400 by being provided in an identical rack.

In FIG. 2, outlined arrows denote exchange of data via an FC or an OCLINK, and broken arrows denote exchange of data via the LAN 50.

The cache disk 160 is a storage medium in which virtual information of the cartridge tape is stored and functions as a virtual storage unit that stores data received by the ICP 150 described later and data read from the cartridge tape of the actual library device 300. The cache disk 160 is a tape volume cache (TVC) and is configured as, for example, a redundant arrays of inexpensive disks (RAID) device. In a database (DB) region of the cache disk 160, LV management information 21 and PV management information 22 described later are stored.

The IDP 170 is a server that is in charge of connection to the physical drives 310 of the tape library device 301. The IDP 170 functions as a writing section to write the data received by the ICP 150 from the host 200 in the cartridge tape via the physical drive 310 of the tape library device 301. The IDP 170 also functions as a reading section to carry out readout of data from the cartridge tape via the physical drive 310 of the library device 301 depending on a reading request from the host 200. The IDP 170 is configured as an Intel architecture (IA) server.

Then, the IDP 170 executes physical driver servers (PDSs) 171.

The PDSs 171 are processes to exchange data with the physical tape drive of the library device 300, and for example, read data from the cartridge tape to write the read data in a predetermined region of the cache disk 160.

The PDSs 171 are achieved by executing a program stored in a storage device (omitted from illustration), such as a memory and a hard disk, by a CPU, not illustrated, of the IDP 170.

The ICP 150 is a server that is in charge of connection to a drive path of the host 200 and functions as a receiving section to receive data from the host 200. The ICP 150 is configured with, for example, an IA server to achieve a mount daemon (MD) 152 and a virtual emulation tape (EMTAPE) 151.

The EMTAPE 151 is a process that makes the tape drives 310 of the tape library device 301 virtually visible to the host 200 and carries out emulation of the tape drives 310 of the library device 301 to control read/write of the LV in the cache disk 160. The EMTAPE 151 is provided by the number of emulated tape drives 310. In other words, the EMTAPE 151 functions as a logical drive. Hereinafter, the EMTAPEs 151 may be referred to as the logical drives 151.

The MD 152 is a process that is in charge of exchange between the ICP 150 and a virtual library manager (VLM) 112 described later and passes a request from the VLM 112 to the EMTAPEs 151.

Then, the EMTAPE stored in s 151 and the MD 152 are achieved by execution of a program a storage device (omitted from illustration), such as a memory and a hard disk, by a CPU, not illustrated, of the ICP 150.

The VLP 110 is a virtual library controller that executes (operates) various processes to achieve a virtual tape environment as a system in cooperation with the ICP 150, the IDP 170, and the like.

The VLP 110 makes a virtual tape visible to the host 200 in cooperation with the ICP 150, the IDP 170, and the like. The VLP 110 is configured as, for example, an IA server. The VLP 110 may be referred to as a virtual library controller 110.

To the VLP 110, the storage device 20 is connected. The storage device 20 is a storage device capable of storing data, such as a hard disk drive (HDD) and a non-volatile memory, for example, and a variety of data used by the VLP 110 and the like are stored therein.

Hereinafter, the LV management information 21 may be referred to as an LV data base (DB) and the PV management information 22 may be referred to as a PVDB.

Further, the VLP 110 is provided with functions (processes) as a virtual library management facility (virtual LMF, VLMF) 111, the VLM 112, a physical library manager (PLM) 113, and a physical library server (PLS) 114.

The PLM 113 is a process that is in charge of physical process (physical layer control unit). The PLM 113 is provided with a function to migrate an LV in the cache disk 160 to a cartridge tape via the tape drive 310 of the actual library device 300 upon receiving an instruction from the VLM 112 described later. The data of the LV stored in the cache disk 160 is moved (saved) to the cartridge tape by this migration process.

The PLM 113 is also provided with a function to load the data of the LV from the cartridge tape via the tape drive 310 of the tape library device 301 and recall the data in the cache disk 160. In a case of accessing (recalling) an LV not present in the cache disk 160, the access is carried out by referring to the corresponding LV information of the PLM 113.

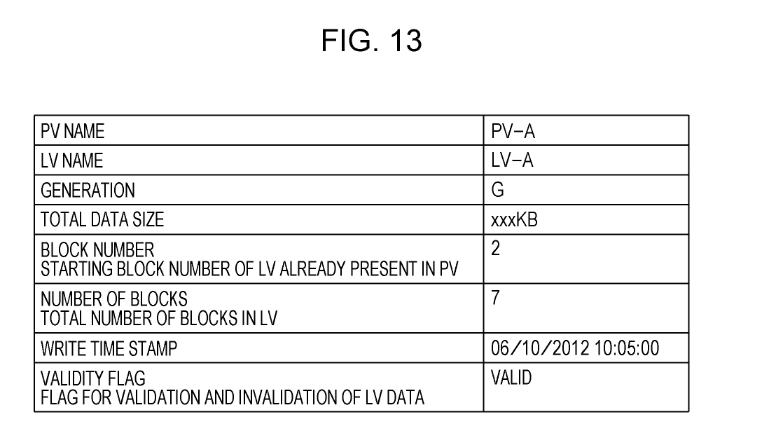

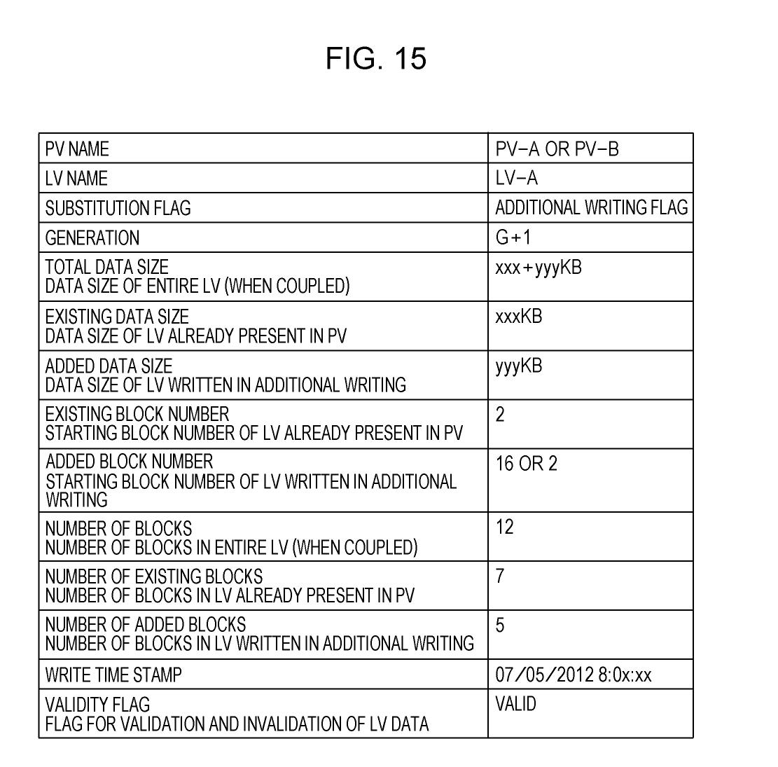

Further, the PLM 113 manages at all times and updates as occasion calls the PV management information 22 related to a physical volume. The PV management information 22 is information related to the LV stored in the PV (refer to FIG. 13, FIG. 15).

The PLS 114 is a process that requests control of the tape library device 301 of the actual library device 300 to the PLP 400.

The virtual storage device 100 is also provided with a function to carry out reconstruction process (reorganization process) of the data stored in the cartridge tape that is mounted in the tape library device 301.

The VLMF 111 is a process that receives a mount request, an information obtaining request, and the like from the host computer 200 to an LV.

Then, in the present virtual library system 1, the VLMF 111 achieves a function as a reception unit that receives an instruction to write data from the host 200 to an LV.

The VLM 112 is a process that is in charge of virtual and logical process (logical layer control unit).

In other words, the VLM 112 controls mounting/unmounting of an LV in the cache disk 160. The VLM 112 also receives a mount request from the VLMF 111 to mount the LV in the logical drive 151. Further, the VLM 112 manages at all times and updates as occasion calls the LV management information 21, which is an information database related to an LV.

In the present virtual library system 1, the VLM 112 achieves a function as a substitution logical volume creation unit 12 (refer to FIG. 1).

The substitution logical volume creation unit 12 creates a substitution logical volume (LV′) in a case that a logical volume (LV) subject to the write request from the host 200 is not present in the cache disk 160.

Hereinafter, in a case of indicating a specific LV, there may be a case of representing by giving a character for identification (for example, an alphabet) together with a hyphen (-) following LV such as LV-A and LV-B, for example. These codes to indicate a specific LV, such as LV-A and LV-B, are used as a logical volume name to identify a logical volume.

A substitution logical volume that is created because an LV subjected to a write request from the host 200 is not present in the cache disk 160 is represented by giving a dash (′) at the end of the code (such as an LV) indicating a logical volume.

For example, a substitution logical volume corresponding to a logical volume LV-A is represented by LV-A′.

In the present virtual library system 1, in a case that a write request (write instruction) is made from the host 200 to an LV not present in the cache disk 160, the substitution logical volume creation unit 12 creates an LV′ in the cache disk 160.

In a case that the LV subjected to a write request from the host 200 is not in the cache disk 160, the virtual storage device 100 makes an LV-A visible to the host 200 as if the LV-A is present in the cache disk 160 corresponds to the write request from the host 200 with an LV-A′.

The substitution logical volume creation unit 12 creates an LV′ by copying stub data (management information) of an LV subject to the write request from the host 200 in the cache disk 160.

The stub data is management information that is created when, for example, an LV is created in a cartridge tape and initialized (puts in a state where data of 16544 bytes in total, management server 10 information, an LVH, a VOL, and an HDR1, is written so as to allow use in a virtual library device). The stub data is a metadata portion of an LV that is present in the cache disk 160 all the time.

The stub data is data of 128 KB or less, and even when an LV in which data of 128 KB or more is stored is removed from the cache disk 160, starting 128 KB of the stub data (LVH, VOL, HDR1, HDR2, and a part of user data) continues to be present in the cache disk 160 all the time.

The stub data has a file name same as that of the migrated logical volume as information. The stub data contains a record table (data block size, compression rate, and the like) in which detailed information of each data block written in the LV is tabulated. The stub data also contains a part of user data in the LV.

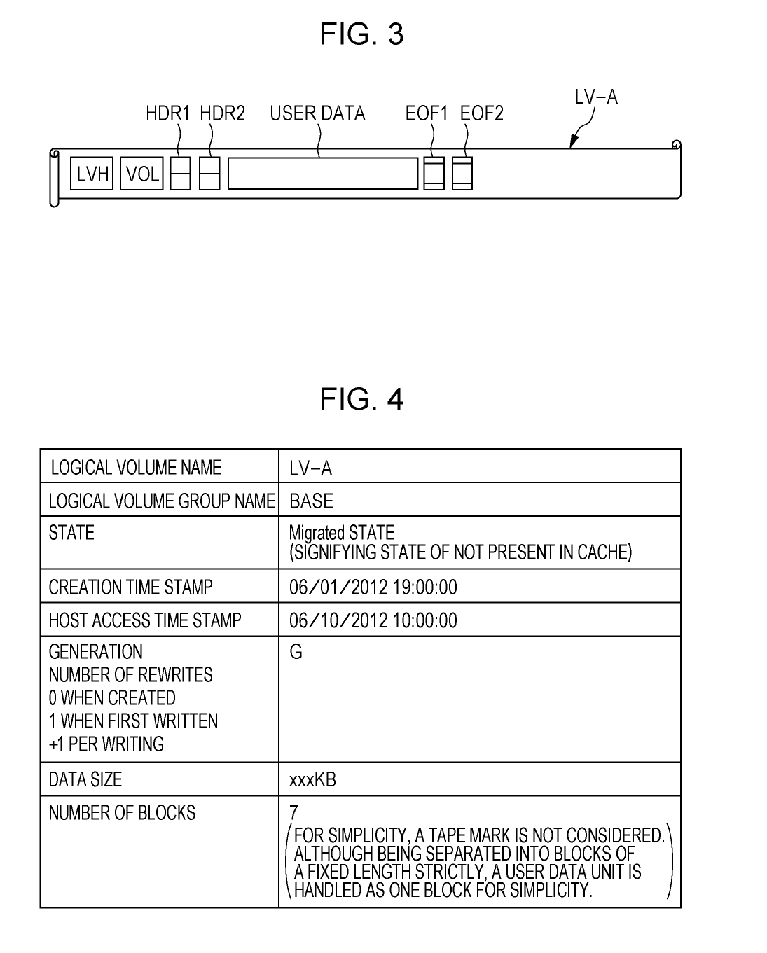

FIG. 3 schematically illustrates a data configuration of a logical volume in the cache disk 160 in the virtual library system 1 as one example of embodiments. In this example illustrated in FIG. 3, the LV-A is illustrated.

The LV is provided with, as illustrated in FIG. 3, an LVH, a VOL, an HDR1, an HDR2, user data, an EOF1, and an EOF2.

Here, an LV-header (LVH) is header information with a generation, an LV name, an LV group name, an LV size, an LV creation date, and the like of the corresponding LV. The LVH has a data size of, for example, 16384 bytes.

In a volume block (VOL), a volume name, an owner, and the like are recorded. In a header 1 block (HDR1), a file name, an update date, and the like are recorded. In a header 2 block (HDR2), a record format, a block length, and the like are recorded.

In user data, data that is read and written from the host 200 is recorded. In an end of file 1 block (EOF1), a file name, an update date, and the like are recorded, and in an end of file 2 block (EOF2), a record format, a block length, and the like are recorded. The VOL, the HDR1, the HDR2, the EOF1 and the EOF2 respectively have a data size of, for example, 80 bytes.

In the LV management information 21 described later, the information described above related to the LV (LV information) is registered.

FIG. 4 is a chart exemplifying LV information in the virtual library system 1 as one example of embodiments.

The LV information is provided with, as illustrated in FIG. 4 here, a logical volume name, a logical volume group name, a state, a creation time stamp, a host access time stamp, a generation, a data size, and a number of blocks.

For example, in this example illustrated in FIG. 4, G indicating a generation is an integer indicating a number of rewrites and is incremented every time rewrite of the corresponding LV is carried out. In this example illustrated in FIG. 4, a number not considering a tape mark is registered in the number of blocks for convenience. Although, strictly, a user data unit is also separated into fixed length blocks, a case of handling the blocks as one block is illustrated for simplicity.

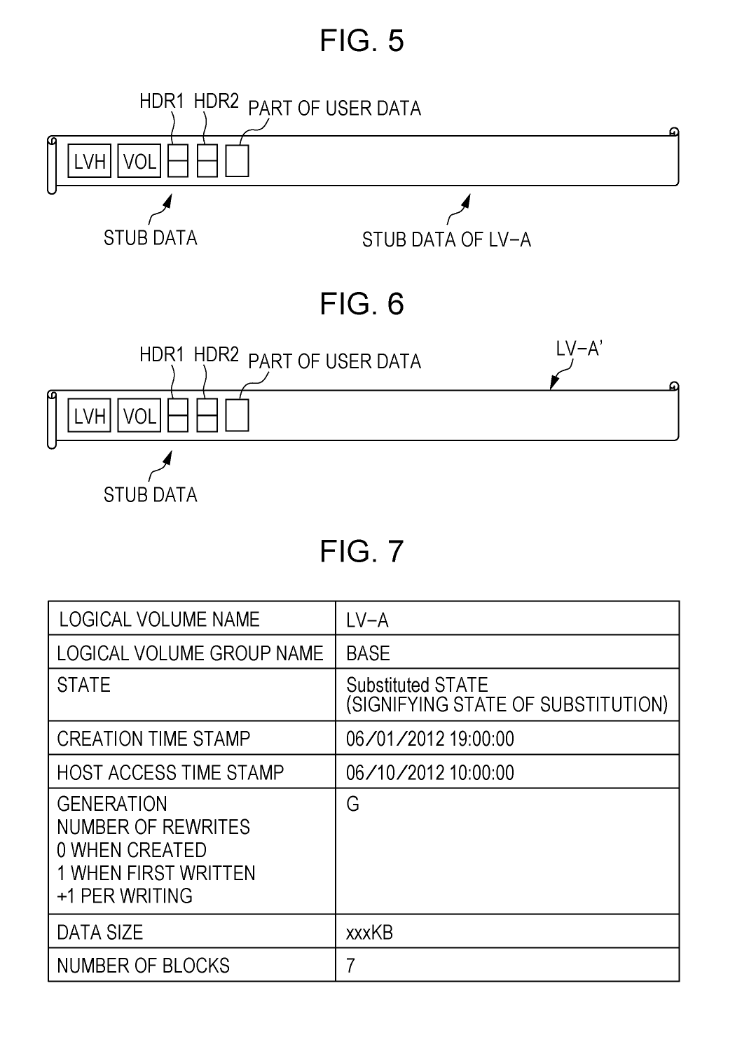

FIG. 5 schematically illustrates a configuration of stub data.

The stub data is provided with, as illustrated in FIG. 5, an LVH, a VOL, an HDR1, an HDR2, and a part of user data.

Data equivalent to the stub data in the LV (VOL, HDR1, HDR2, and a starting portion of user data) is written directly in the LV, and this portion is present in the cache disk 160 all the time.

That an LV is present in the cache disk 160 signifies that all of the user data portion of the LV is present in the cache disk 160 (refer to FIG. 3). In contrast, that an LV is not present in the cache disk 160 signifies that only a portion of user data is present in the cache disk 160 (refer to FIG. 4). In other words, the user data portion except for the stub data portion is not present in the cache disk 160. The information equivalent to the stub data is also managed in the LV management information 21.

When creating an LV′, the substitution logical volume creation unit 12 takes over the LV information corresponding to the LV′ already registered in the LV management information 21 for registration in the LV management information 21 as the LV information of this LV′.

FIG. 6 schematically illustrates a data configuration of a substitution logical volume (LV′) in the virtual library system 1 as one example of embodiments, and FIG. 7 is a chart exemplifying LV information of the substitution logical volume. The LV′ exemplified in FIG. 7 corresponds to the LV exemplified in FIG. 4.

An LV′ is created by copying the stub data illustrated in FIG. 5. In other words, an LV′ is provided with, as illustrated in FIG. 6 and FIG. 7, an LVH, a VOL, an HDR1, an HDR2, and a part of user data similar to the stub data (refer to FIG. 5).

The substitution logical volume creation unit 12 sets identification information indicating a state of substitution in LV information of the created LV in the LV management information 21 as illustrated in FIG. 7. In the LV management information 21 exemplified in FIG. 7, “substituted state” indicating a state of substitution is registered as a state. In other words, in the LV information, “substituted state” is set as a state thereof.

As information set as this state, there are “migrated state” and “mounted state” other than the “substituted state” described above. The “migrated state” and the “mounted state” registered as a state of the LV information are already understood and descriptions thereof are omitted.

In a case that it is difficult to secure a storage region for the LV′ in the cache disk 160, the substitution logical volume creation unit 12 removes one or more LVs equivalent to capacity allowing storage of this LV′ from the cache disk 160.

For example, the substitution logical volume creation unit 12 determines the LV to be deleted from the cache disk 160 in accordance with a least recently used (LRU) algorithm. In other words, the substitution logical volume creation unit 12 deletes LVs with low frequency of access with a priority out of the LVs in the cache disk 160 from the cache disk 160.

A substitution logical volume control unit 13 carries out process to the LV′ created by the substitution logical volume creation unit 12. For example, the substitution logical volume control unit 13 carries out write and migration of data to the LV′ in accordance with a write instruction from the host 200.

In the present virtual library system 1, the VLM 112, the EMTAPEs 151, and the PLM 113 achieve a function as the substitution logical volume control unit 13 (refer to FIG. 1).

Specifically, the VLM 112 carries out control of mounting/unmounting of an LV, and the EMTAPEs 151 carry out control of read/write of the LV. The PLM 113 carries out control of migration.

(A) Write Process

Here, a virtual library (an actual library is also similar) is not capable of overwriting written data in the middle due to the structure. Therefore, there are two types of process for write of data, which are “additional writing” to write new additional data at the rear of existing data in a volume (tape) and “rewrite” to overwrite a tape from the start with new data.

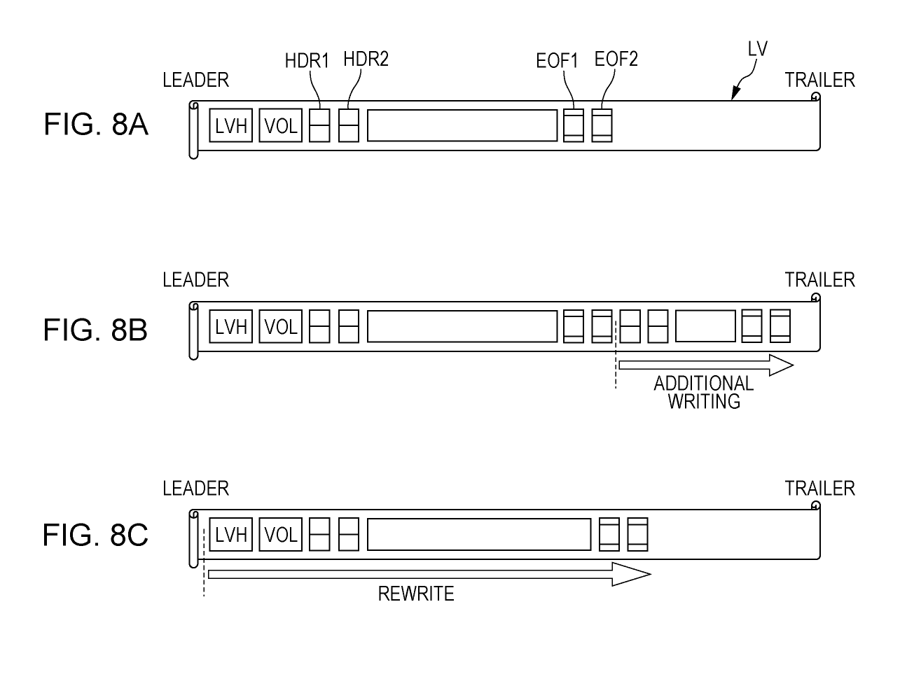

FIGS. 8A through 8C illustrate update of an LV by write process in the virtual library system 1 as one example of embodiments. FIG. 8A illustrates an LV before writing (initial state), FIG. 8B illustrates an LV after additional write process is carried out, and FIG. 8C illustrates an LV after rewrite process is carried out.

In a case that write of data to an LV in a state illustrated in FIG. 8A (initial state) is carried out by additional write process, as illustrated in FIG. 8B, new data is written from a rear end of data recorded previously.

In contrast, in a case that write of data to an LV in a state illustrated in FIG. 8A (initial state) is carried out by rewrite process, as illustrated in FIG. 8C, new data is written from the start (leader) of an LV to overwrite data recorded previously.

Whether a write request is additional write process or rewrite process is specified by, for example, the host 200 that issues the write request. At the stage of accepting a positioning request from the host 200, the VLMF 111 and the VLM 112 makes a decision whether the process is additional write process or rewrite process.

In the present virtual library system 1, an LV′ that is created by the substitution logical volume creation unit 12 also corresponds to the two types of write of data, which are additional writing and rewrite. An LV′ is finally unmounted from the logical drive 151.

(A-1) Additional Writing

In a case that a write request to an LV′ is carried out, and in a case that the write request is additional write process, the substitution logical volume control unit 13 carries out data write from the start of the LV′ by inhibiting execution of a positioning command accompanied by the write request.

In a case of additional write process, the host 200 issues a positioning command that requests to position a logical head on a trailer side of the EOF2 that is recorded on the most trailer side at the time of executing write process in the LV. The logical head is a virtual device that carries out reading and writing of data to an LV.

In accordance with the request (positioning command) from the host 200, the substitution logical volume control unit 13 positions a logical head on a trailer side of the EOF2 that is recorded on the most trailer side in the current state in the LV. In this way, while existing data is remained in the LV, preparation to write new data at the rear thereof is made.

It is to be noted that this is a case of an LV in which a user data portion is present in the cache. In the LV′ that is created by the substitution logical volume creation unit 12 as described before, only the stub data is written.

With that, in a case that a positioning command is issued to the LV′, a control unit of the substitution logical volume control unit 13, that is, the EMTAPE 151 skips and inhibits the positioning command. After that, the host 200 writes additional data in the LV′.

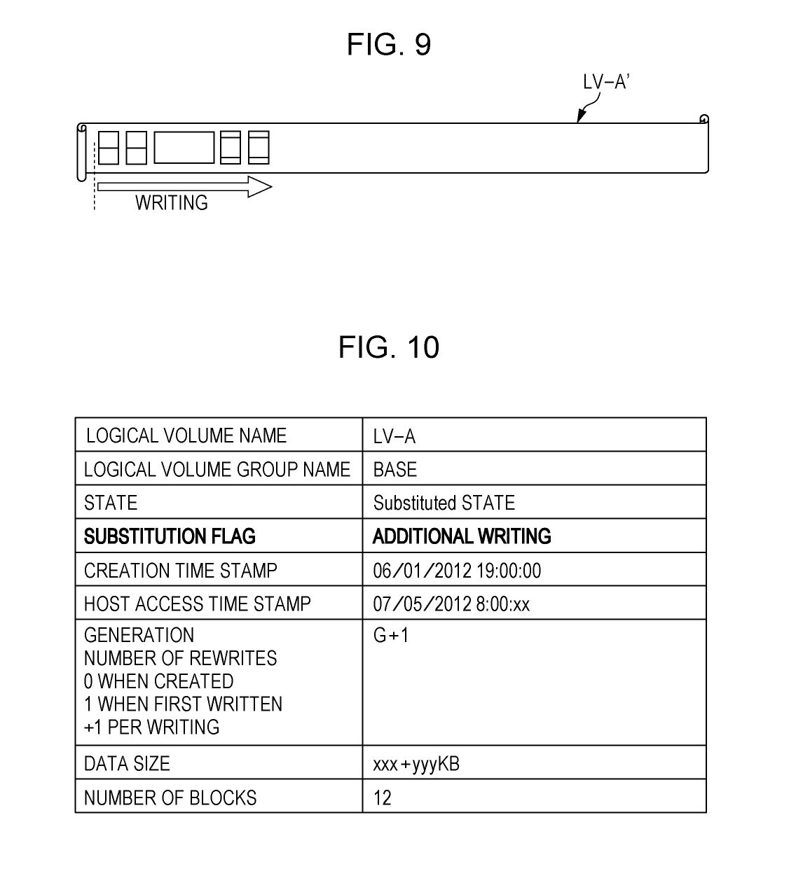

FIG. 9 illustrates additional write process to a substitution logical volume in the virtual library system 1 as one example of embodiments.

As described above, in a case that a positioning command is issued to the LV′, the substitution logical volume control unit 13 skips the process of the positioning command, thereby writing of new data is carried out from the leader of the LV′ by the logical head as illustrated in FIG. 9.

The stub data that is written in the LV′ previously is overwritten by newly written additional data.

As soon as the additional write process is completed, the substitution logical volume control unit 13 adds a flag indicating additional writing (additional writing flag) to the information of the corresponding LV′ in the LV management information 21 as illustrated in FIG. 10.

FIG. 10 is a chart exemplifying LV information on an LV′ in which additional write process is carried out in the virtual library system 1 as one example of embodiments.

In this example illustrated in FIG. 10, “substituted state” indicating a state of substitution is registered as the state and information indicating additional writing is also recorded as a substitution flag.

(A-2) Rewrite

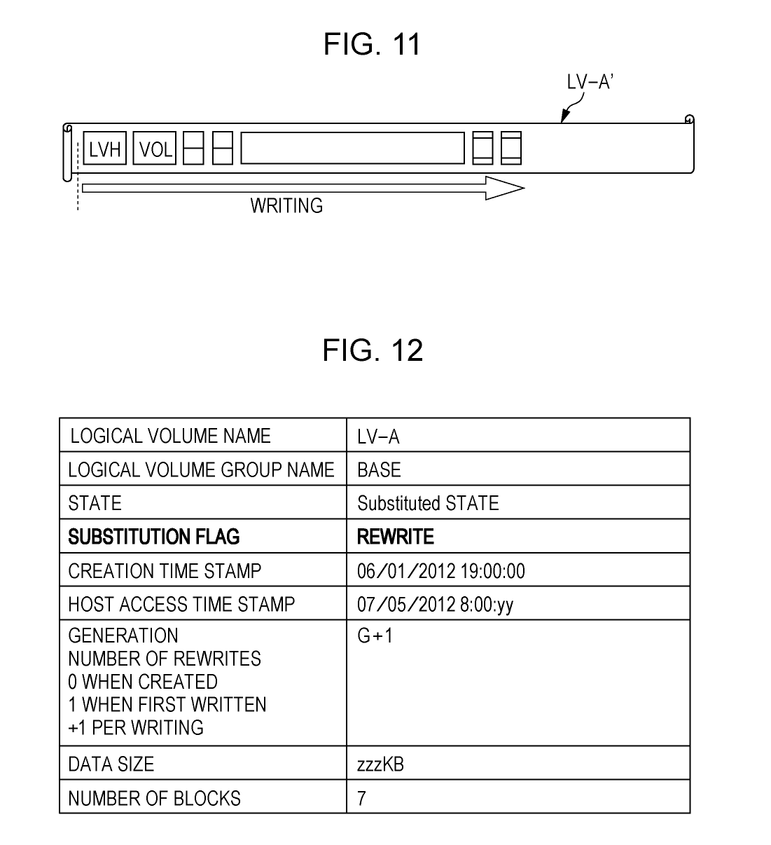

FIG. 11 illustrates rewrite process to a substitution logical volume in the virtual library system 1 as one example of embodiments.

In a case of rewrite process, a write request sent from the host 200 is not accompanied by a positioning command. Accordingly, as illustrated in FIG. 11, different from the additional write process described above, the substitution logical volume control unit 13 writes data in the LV′ immediately. The stub data that is written in the LV′ previously is overwritten by the new data.

As soon as the rewrite process is completed, a rewrite flag is added to the LV information of the LV management information 21 as illustrated in FIG. 12.

FIG. 12 is a chart exemplifying LV information on an LV′ in which rewrite process is carried out in the virtual library system 1 as one example of embodiments.

In this example illustrated in FIG. 12, “substituted state” indicating a state of substitution is registered as the state and information indicating rewrite is also recorded as a substitution flag.

(B) Migration

When data update occurs in the cache disk 160, a migration process unit of the substitution logical volume control unit 13, that is, the PLM 113 is provided with a function to migrate the LV to a cartridge tape (PV) by the tape drive 310 of the actual library device 300.

The substitution logical volume control unit 13 achieves migration mainly using a function of the PLM 113.

(B-1) Additional Writing

FIG. 13 is a chart exemplifying LV information registered in the PV management information 22 in the virtual library system 1 as one example of embodiments.

The LV information in the PV management information 22 is provided with, as illustrated in FIG. 13 here, a PV name, an LV name, a generation, a total data size, a block number, a number of blocks, a writing time stamp, and a validity flag. The block number is a starting block number of an LV that is already present in the PV. The number of blocks is a total number of blocks of the LV. The validity flag is a flag for validation or invalidation of LV data. The LV information is already understood and descriptions thereof are omitted.

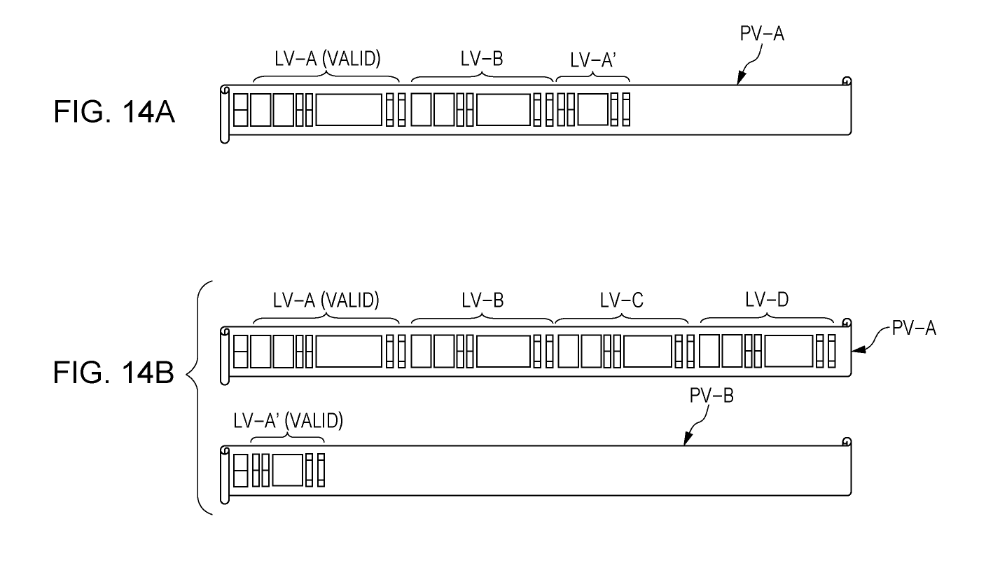

FIGS. 14A and 14B illustrate migration of additionally written data in the virtual library system 1 as one example of embodiments. FIG. 14A indicates a state of migrating an LV (LV-A′) newly to a PV-A in which LVs (LV-A, LV-B) are stored already. FIG. 14B indicates a state of storing an LV-A′ in a PV-B because it is difficult to secure a region to store the LV-A′ in the PV-A.

The substitution logical volume control unit 13 mounts a PV-A that is already stored in the LV-A in the tape drive 310 as illustrated in FIG. 14A with reference to information of the LV-A in the PV management information 22 (refer to FIG. 13) and migrates data of the LV-A′ to this PV-A. In other words, the LV-A′ is recorded on the rearmost side of the data that is registered already in the PV-A.

In a case that it is difficult to secure capacity to allow storage of the data of the LV-A′ in the PV-A, as illustrated in FIG. 14B, the substitution logical volume control unit 13 mounts another PV (PV-B) that has room in capacity in the tape drive 310 and migrates the LV-A′ to this PV-B. In other words, the LV-A′ is recorded on the rearmost side of the data that is registered already in the PV-B.

As soon as the migration is completed, the substitution logical volume control unit 13 registers information of the LV-A′ in the PV-A or the PV-B to which the migration is carried out in the PV management information 22. On this occasion, as illustrated in FIG. 15, information of the LV-A′ newly written in the PV is registered in the PV management information 22 by taking the information of the LV that is already registered in the PV (refer to FIG. 13) into account.

FIG. 15 is a chart exemplifying LV information on a substitution logical volume that is registered in the PV management information 22 in the virtual library system 1 as one example of embodiments. In the example illustrated in FIG. 15, LV information in a case of migrating data related to an LV-A′ to a PV-A or a PV-B by additional write process is illustrated. This example illustrated in FIG. 15 indicates a state immediately after migration.

The LV information of the LV′ to be registered in the PV management information 22 has, as illustrated in FIG. 15, a PV name, an LV name, a substitution flag, a generation, a total data size, an existing data size, an added data size, an existing block number, an added block number, a number of blocks, a number of existing blocks, a number of added blocks, a writing time stamp, and a validity flag, for example.

In FIG. 15, an item same as the already described information represents the similar item, and descriptions thereof are omitted.

In the substitution flag, information indicating an additional writing flag is registered. The existing data size is a data size (xxx KB) of the LV that is stored before carrying out the migration of the PV-A. The added data size is a size (yyy KB) of the data that is written in additional writing.

The total data size indicates a data size of the entire LV, in other words, when coupled. In the example illustrated in FIG. 15, it is indicated that migration (writing) of the LV-A of yyy KB is carried out in a state where the LV of xxx KB is stored in the PV previously.

The existing block number is a starting block number of the LV that is present in the PV previously. In this example illustrated in FIG. 15, “PV-A or PV-B” is registered in the PV name. This indicates that migration is carried out to a PV-A in a case that this PV-A has a free space and that migration is carried out to a PV-B in a case that a PV-A does not have a free space and it is difficult to carry out additional writing.

The added block number is a starting block number of the LV-A that is written in additional writing. In the example illustrated in FIG. 15, the registration of “16 or 2” in the added block number indicates that the LV-A is written in a block 16 of a PV-A as the start in a case of carrying out additional writing to the PV-A in which an LV is written already. In a case of not being capable of carrying out additional writing because the PV-A does not have a free space, the registration indicates that the LV-A is written in a block 2 of a PV-B as the start.

The number of existing blocks is a number of blocks of the LV that is already present in the PV, and the number of added blocks is a number of blocks of the LV that is written in additional writing. The number of blocks is a number of blocks of all the LVs (when coupled) in the PV and becomes a total of the number of existing blocks and the number of added blocks.

The substitution logical volume control unit 13 (PLM 113) synchronizes the LV information of the LV-A that is registered in the PV management information 22 (refer to FIG. 13) with the LV information of the LV-A′ (refer to FIG. 15). The substitution logical volume control unit 13 (VLM 112) synchronizes the LV information of the LV-A in the LV management information 21 that is managed by itself (refer to FIG. 7) with the LV information of the LV-A′ (refer to FIG. 10).

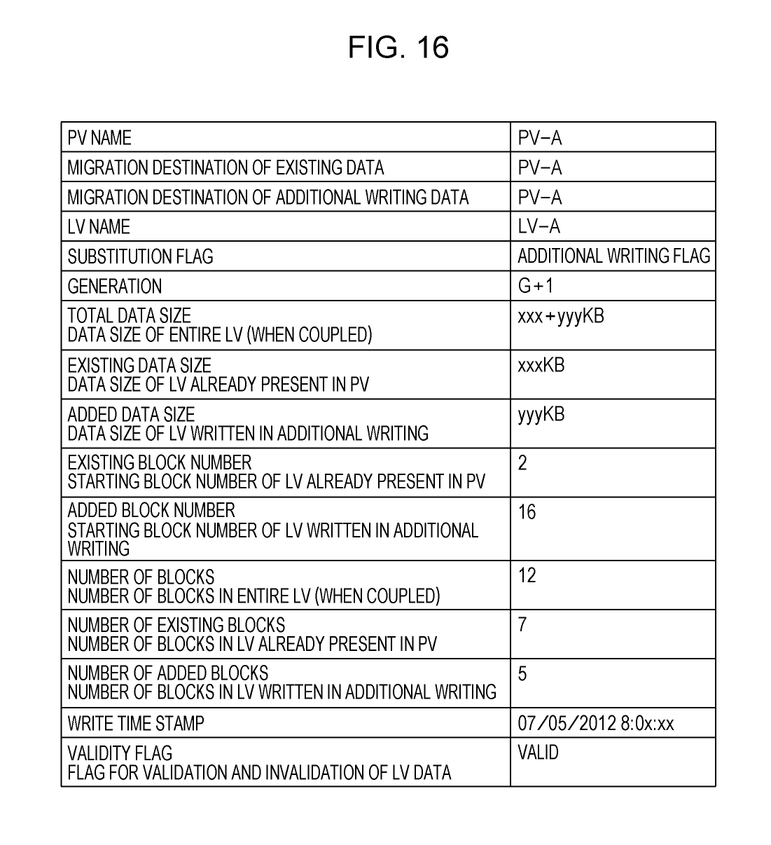

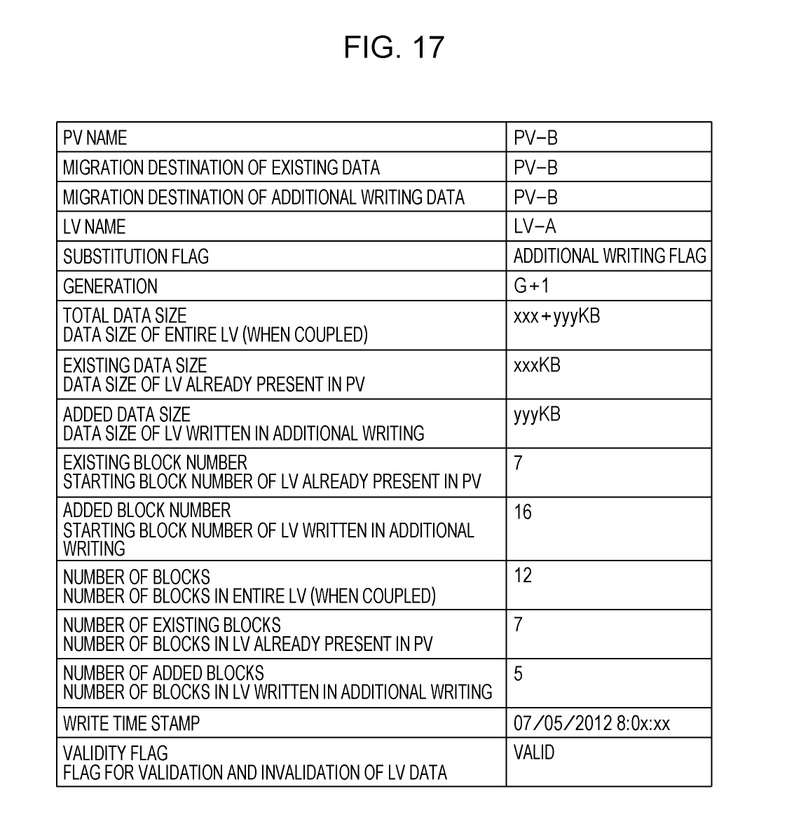

FIG. 16 and FIG. 17 are respective charts exemplifying LV information of the PV management information 22 after synchronized with a substitution logical volume in the virtual library system 1 as one example of embodiments. FIG. 16 illustrates the LV information in a case that the substitution logical volume is migrated to an identical PV. FIG. 17 illustrates the LV information in the PV management information 22 that is updated after performing reorganization (described later) in a case that the substitution logical volume is not migrated to an identical PV.

As illustrated in FIG. 16 and FIG. 17 here, in the LV information of the PV management information 22, a migration destination of existing data and a migration destination of additional writing data are managed. This enables the substitution logical volume control unit 13 to recognize whether or not existing data (LV-A) and additional data (LV-A′) are migrated to an identical PV.

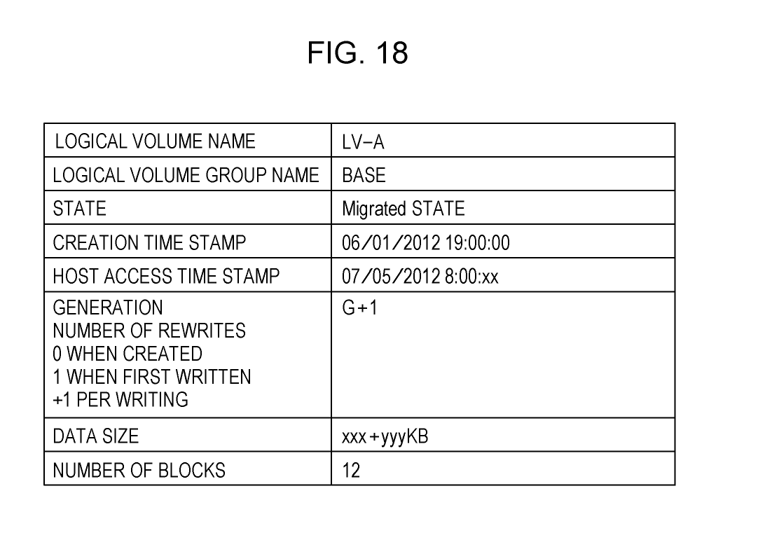

FIG. 18 is a chart exemplifying LV information of the LV management information 21 after synchronized with a substitution logical volume in the virtual library system 1 as one example of embodiments. The LV information illustrated in FIG. 18 indicates a state of carrying out update to the LV information illustrated in FIG. 7. In other words, other than the state being altered to “migrated state” that indicates a state of being migrated, the host access time stamp, the generation, the data size, and the number of blocks are updated respectively to values that take the LV-A′ into account.

At the stage of completing update of the PV management information 22 and the LV management information 21, the role of the LV′ is finished. It does not have to leave the LV′ in the present virtual storage device 100 as is, so that the substitution logical volume control unit (substitution logical volume deletion unit) 13 deletes the LV-A′ from the cache disk 160. In addition, the substitution logical volume control unit (substitution logical volume deletion unit) 13 deletes information related to the LV-A′ from the PV management information 22 and the LV management information 21.

Due to the properties as a backup device for the virtual library system 1, in the virtual library system 1, a read request is hardly carried out immediately from the host 200 to the data written immediately before. That there is an LV not present in the cache disk 160 signifies that the capacity of the cache disk 160 is full. In order to respond to a further write request from the host 200, increasing a free space in the cache disk 160 as much as possible is advantageous for administration. In the present virtual library system 1, the LV′ is deleted from the virtual storage device 100 for these reasons.

After that, when recall process and the like are executed to the LV-A, data of the existing LV-A where the validity flag is on (set as valid) in the PV management information 22 and data of the newly added LV-A′ are coupled as one data item to be recalled.

In a case that a write request arrives from the host 200 during execution of migration, the substitution logical volume creation unit 12 creates an LV′ again and corresponds to the write request.

In the migration described above, in a case that the existing data and the additional data are not migrated to an identical PV, and in a case that a read request from the host 200 to the LV-A is carried out, one LV has to be recalled from a plurality of PVs. Hereinafter, migration of existing data and additional data to separate PVs is called as division migration.

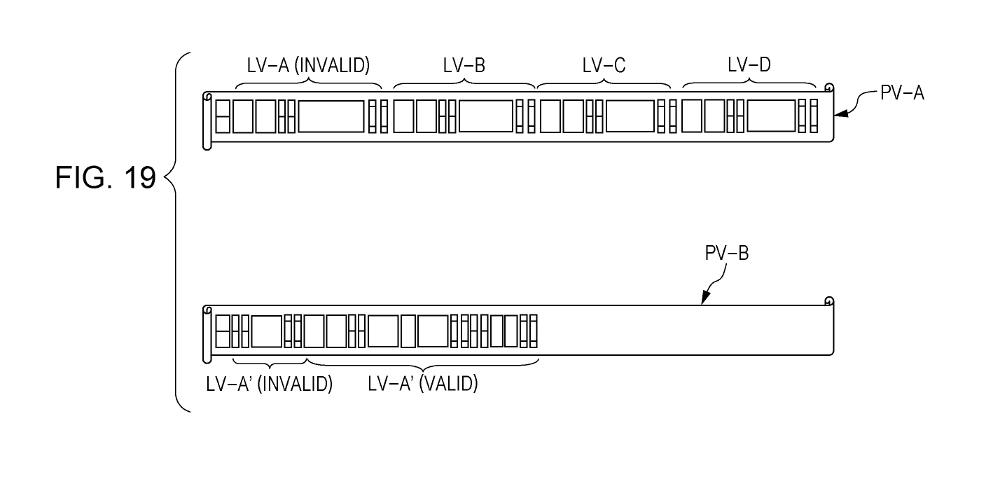

FIG. 19 is a diagram exemplifying a PV in which division migration is carried out in the virtual library system 1 as one example of embodiments.

In this example illustrated in FIG. 19, two PVs of a PV-A and a PV-B are illustrated, and an LV-A, an LV-B, an LV-C, and an LV-D are stored in the PV-A and an LV-A′ is stored in the PV-B, respectively. In other words, data of the LV-A is migrated to the PV-A and data of the LV-A′ that is newly added to the LV-A is migrated to the PV-B, respectively.

In this example illustrated in FIG. 19, when a read request is issued from the host 200 to the LV-A (in other words, LV-A+LV-A′), one LV (LV-A and LV-A′) has to be recalled from the two PVs (PV-A, PV-B).

For such recall of the division migrated LV-A, it turn out to take more time to recall process compared with a case of carrying out recall from one PV because a mechanical behavior to mount a plurality of PVs (PV-A, PV-B) to the respective separate tape drives 310 is produced.

With that, in the present virtual library system 1, reorganization is executed to the division migrated LV (LV-A).

While recall of an LV is carried out in PV in a reorganization approach in the past, the substitution logical volume control unit 13 couples the divided data (LV-A+LV-A′) in the LV-A′ in the cache disk 160 in the present virtual library system 1.

Then, the substitution logical volume control unit 13 executes migration of the coupled LV-A as one continuous data to the PV-B again.

After the migration is completed, the information of the LV-A′ is updated, the data of the coupled LV-A, LV-A′ is defined as valid, and the data of the LV-A, LV-A′ that are stored separately are defined as invalid (refer to FIG. 19). As a result, after that, when a read request is carried out from the host 200 to the LV (LV-A), recall process from one PV (PV-B) is carried out and it does not take any more time than a recall processing time from one PV.

In other words, it is possible to shorten the time period taken for recall of the LV by carrying out remigration by collecting the LVs that are division migrated to a plurality of PVs by reorganization as one data item.

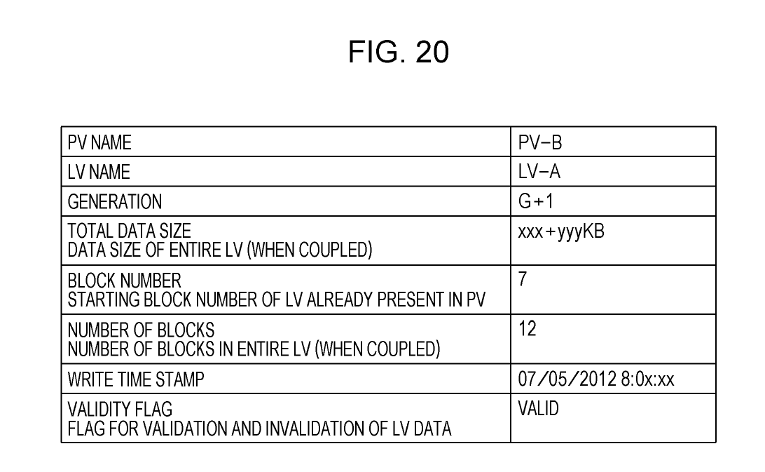

FIG. 20 is a chart exemplifying LV information of the PV management information 22 after reorganization in the virtual library system 1 as one example of embodiments. The LV information illustrated in FIG. 20 here indicates LV information in the PV management information 22 after synchronization in a case that a substitution logical volume is not migrated to an identical PV.

When the division migrated data is coupled to continuous data, which is how it is supposed to be, by reorganization, as illustrated in FIG. 20 here, the substitution logical volume control unit 13 deletes undesired information from the LV information illustrated in FIG. 15 for registration in the PV management information 22. In the example illustrated in FIG. 20, from the LV information illustrated in FIG. 15, a substitution flag, an existing data size, an added data size, an added block number, a number of existing blocks, and a number of added blocks are deleted as undesired information.

The reorganization process described above related to the division migration is carried out immediately after the LV-A′ is migrated to the PV-B. It is to be noted that the reorganization process described above related to the division migration is process that applies a load to a virtual library (mainly back end actual library device 300), so that the process may be executed by choosing low load timing.

Then, the LV-A information in the PV management information 22 (refer to FIG. 13) is synchronized with the LV-A′ information (refer to FIG. 15). Meanwhile, the logical layer control unit synchronizes LV-A information registered in a database of all LVs (LV management information 21) that is managed by itself (refer to FIG. 4) with the LV-A′ information (refer to FIG. 10) (refer to FIG. 18). At this stage, the role of the LV-A′ is finished. There is no reason to leave the LV-A′ as is in the virtual library, so that the LV-A′ is deleted from the cache. Of course, the information related to the LV-A′ registered in the PV management information 22 and the LV management information 21 is also deleted.

Regarding the reasons to delete the LV-A′, due to the properties as a backup device for the virtual library system 1, in a virtual library, a read request is hardly carried out from the host 200 immediately to the data that is written immediately before. In addition, that an LV not present in the cache disk 160 is present signifies that the capacity of the cache disk 160 is full. In order to respond to a further write request from the host 200, it is advantageous for administration to increase a free space in the cache disk 160 as much as possible. In the present virtual library system 1, for these reasons, the LV-A′ is deleted from the virtual storage device 100.

(B-2) Rewrite

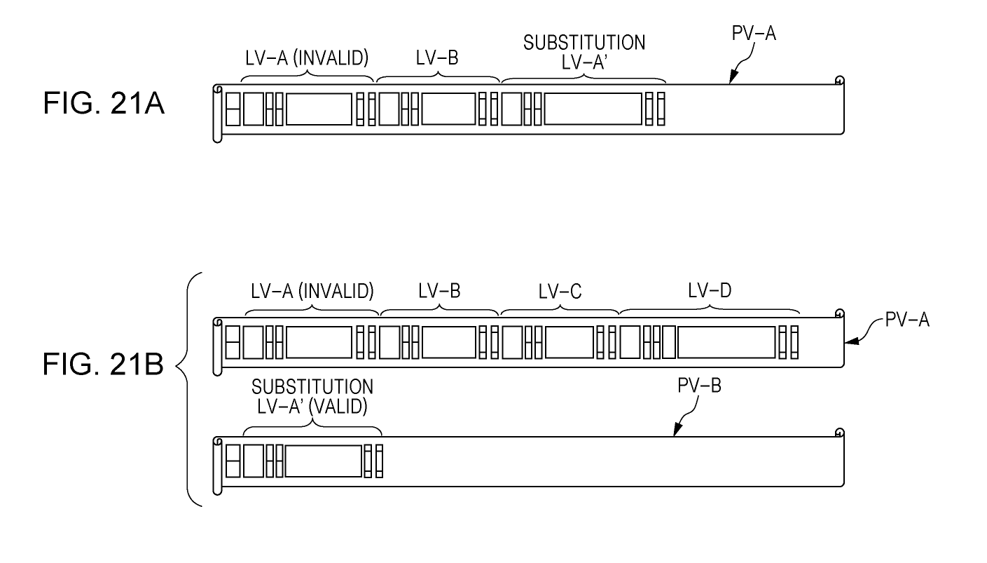

FIGS. 21A and 21B illustrate migration of rewritten data in the virtual library system 1 as one example of embodiments. FIG. 21A illustrates a state of newly migrating an LV-A′ to a PV-A in which an LV-A is stored already. FIG. 21B illustrates a state of storing an LV-A′ in a PV-B in which an LV-A is not stored.

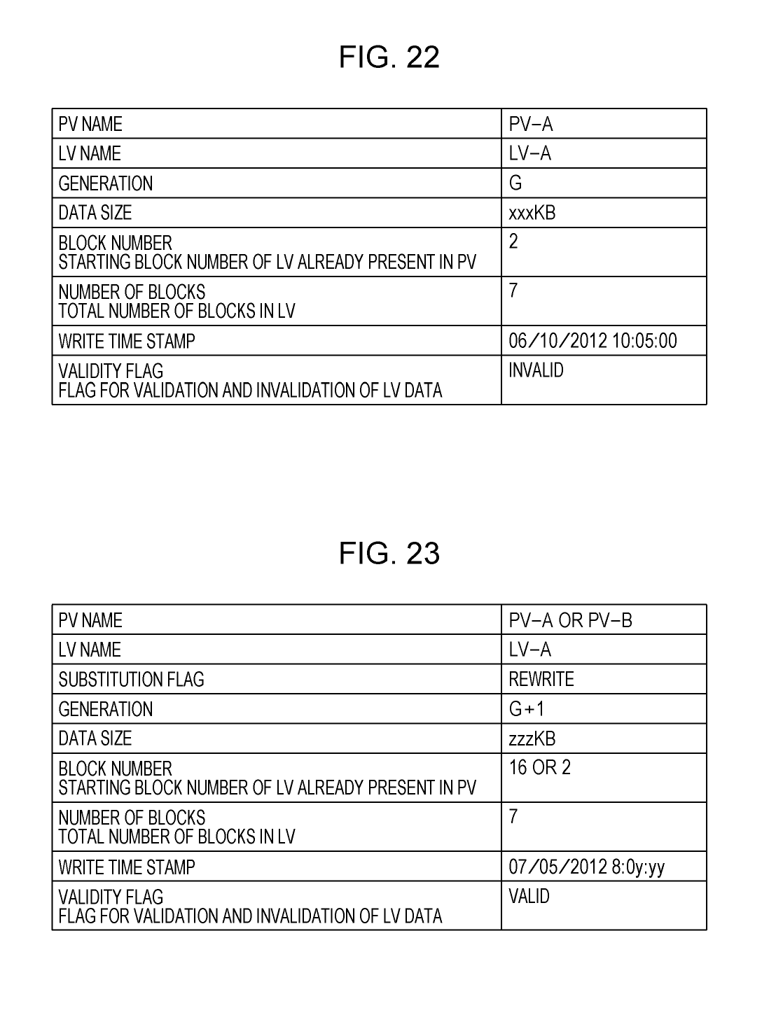

FIG. 22 is a chart exemplifying LV information on a logical volume registered in the PV management information 22 in the virtual library system 1 as one example of embodiments. FIG. 23 is a chart exemplifying LV information on a substitution logical volume registered in the PV management information 22 in the virtual library system 1 as one example of embodiments. In the example illustrated in FIG. 23, LV information in a case of migrating data related to an LV-A′ to a PV-A or a PV-B by rewrite process is illustrated. Before migration of an LV-A′, the LV information illustrated in FIG. 22 is registered in the PV management information 22.

With reference to the LV-A information in the PV management information 22 (refer to FIG. 13), the substitution logical volume control unit 13 mounts the PV-A in which an LV-A is stored already in the tape drive 310 as illustrated in FIG. 21A and migrates the data of the LV-A′ to this PV-A.

In a case that it is difficult to secure capacity to allow storage of the data of the LV-A′ in the PV-A, as illustrated in FIG. 21B, the substitution logical volume control unit 13 mounts another PV (PV-B) that has room in the capacity in the tape drive 310 and migrates the LV-A′ to this PV-B.

As soon as the migration is completed, the substitution logical volume control unit 13 registers the LV-A′ information to a PV-A or a PV-B to which migration is carried out in the PV management information 22 (refer to FIG. 23). At this time, the data of the LV-A stored in the PV-A (refer to FIG. 22) becomes invalid.

The substitution logical volume control unit 13 (PLM 113) synchronizes the LV information of the LV-A registered in the PV management information 22 (refer to FIG. 22) with the LV information of the LV-A′ (refer to FIG. 23). The substitution logical volume control unit 13 (VLM 112) synchronizes the LV information of the LV-A in the LV management information 21 that is managed by itself (refer to FIG. 7) with the LV information of the LV-A′ (refer to FIG. 12).

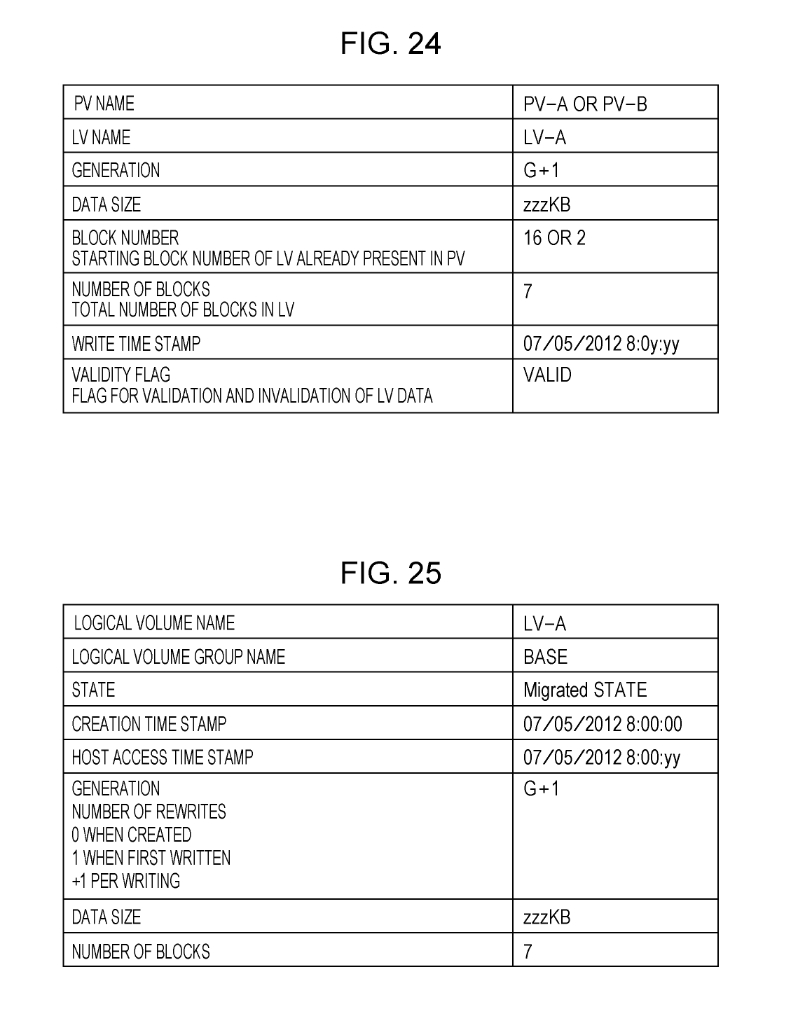

FIG. 24 is a chart exemplifying LV information of the PV management information 22 after synchronized with a substitution logical volume in the virtual library system 1 as one example of embodiments. The LV information illustrated in FIG. 24 here illustrates a state of carrying out update to the LV information illustrated in FIG. 13. In other words, a generation, a data size, and a number of blocks are updated respectively depending on the LV-A after rewrite.

FIG. 25 is a chart exemplifying LV information of the LV management information 21 after synchronized with a substitution logical volume in the virtual library system 1 as one example of embodiments. The LV information illustrated in FIG. 25 here illustrates a state of carrying out update to the LV information illustrated in FIG. 7. In other words, other than the state being altered to “migrated state” indicating a state of being migrated, a host access time stamp, a generation, a data size, and a number of blocks are updated respectively depending on the LV-A′.

In such a manner, at the stage of completing update of the PV management information 22 and the LV management information 21, the role of the LV-A′ is finished. There is no reason to leave the LV-A′ in the present virtual storage device 100 as is, so that the substitution logical volume control unit 13 deletes the LV-A′ from the cache disk 160. In addition, the substitution logical volume control unit 13 deletes information related to the LV-A′ from the PV management information 22 and the LV management information 21.

Regarding the reasons to delete the LV-A′, due to the properties as a backup device for the virtual library system 1, in a virtual library, a read request is hardly carried out from the host 200 immediately to the data that is written immediately before. That an LV not present in the cache disk 160 is present signifies that the capacity of the cache disk 160 is full. In order to respond to a further write request from the host 200, it is advantageous for administration to increase a free space in the cache disk 160 as much as possible. In the present virtual library system 1, for these reasons, the LV-A′ is deleted from the virtual storage device 100.

(2) Behavior

As one example of embodiments configured as described above, descriptions are given to each process in the virtual library system 1.

(A) Mounting Process

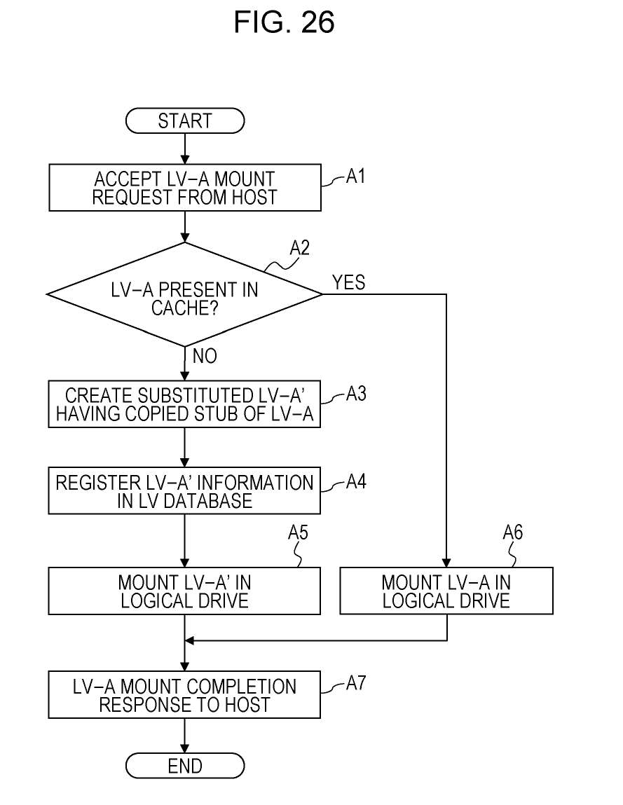

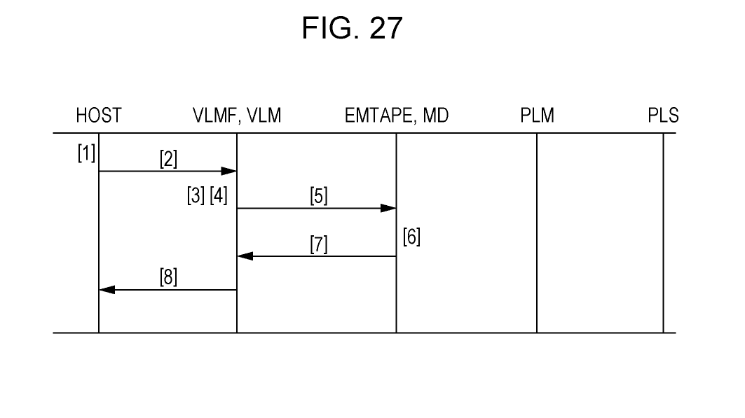

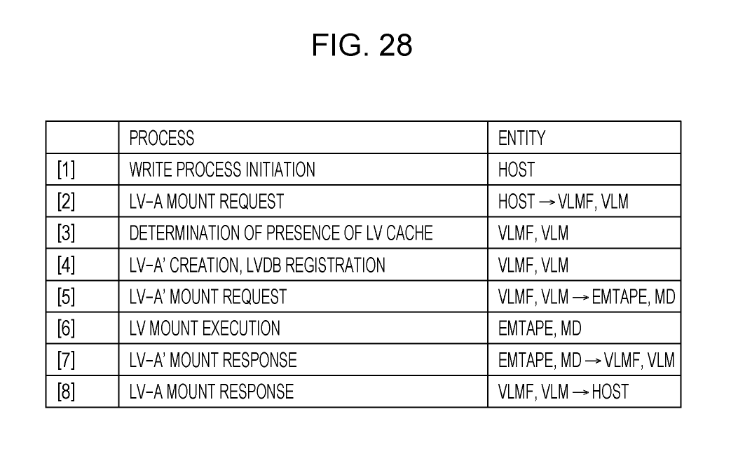

With reference to FIG. 27 and FIG. 28, in accordance with a flowchart illustrated in FIG. 26 (steps A1 through A7), mounting process in the virtual library system 1 as one example of embodiments is described. FIG. 27 is a sequence diagram illustrating mounting process in the virtual library system 1 as one example of embodiments, and FIG. 28 illustrates each process in FIG. 27 and entities thereof.

When write process to an LV-A is initiated in the host 200 (refer to code [1] in FIG. 27 and FIG. 28), a request to mount the LV-A is issued from the host 200 to the VLMF 111 and the VLM 112 of the virtual library system 1 (refer to code [2] in FIG. 27 and FIG. 28). In the VLMF 111 and the VLM 112, the mount request is accepted (step A1 in FIG. 26).

The VLMF 111 and the VLM 112 determine whether or not the LV-A according to the write request is present in the cache disk 160 (refer to code [3] in FIG. 27 and FIG. 28; step A2 in FIG. 26). In a case that the LV-A is not present in the cache disk 160 (refer to NO route in step A2), the VLMF 111 and the VLM 112 (substitution logical volume creation unit 12) create an LV-A′ having stub data of the LV-A copied therein in step A3. In step A4, the VLMF 111 and the VLM 112 register the LV-A′ information created in the LV management information 21 (refer to code [4] in FIG. 27 and FIG. 28).

In step A5, the VLMF 111 and the VLM 112 issue a request to mount an LV-A′ to the EMTAPE 151 and the MD 152 (refer to code [5] in FIG. 27 and FIG. 28). In a case that the LV-A is present in the cache disk 160 (refer to YES route in step A2), the VLMF 111 and the VLM 112 issue a request to mount the LV-A to the EMTAPE 151 and the MD 152 in step A6 (refer to code [6] in FIG. 27 and FIG. 28). The EMTAPE 151 and the MD 152 carry out a mount response of the LV-A or the LV-A′ to the VLMF 111 and the VLM 112 (refer to code [7] in FIG. 27 and FIG. 28).

After that, in step A7, the VLMF 111 and the VLM 112 respond to the host 200 of mount completion (refer to code [8] in FIG. 27 and FIG. 28) to terminate the process.

(B) Write Process

Next, descriptions are given to write process in the present virtual library system 1.

(B-1) Additional Write Process

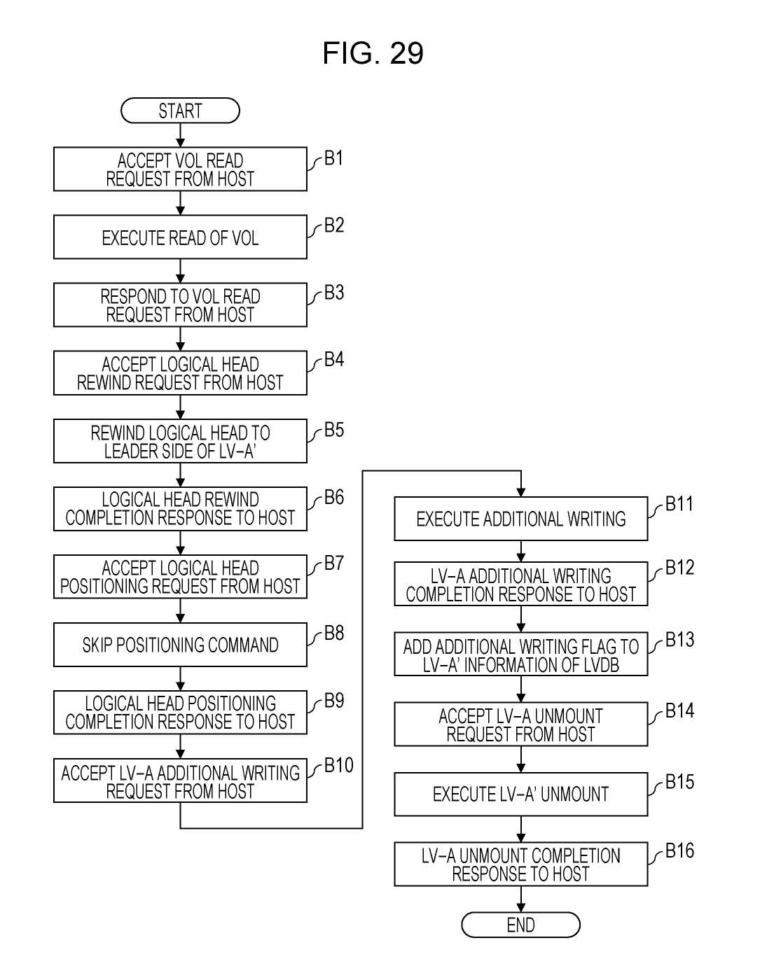

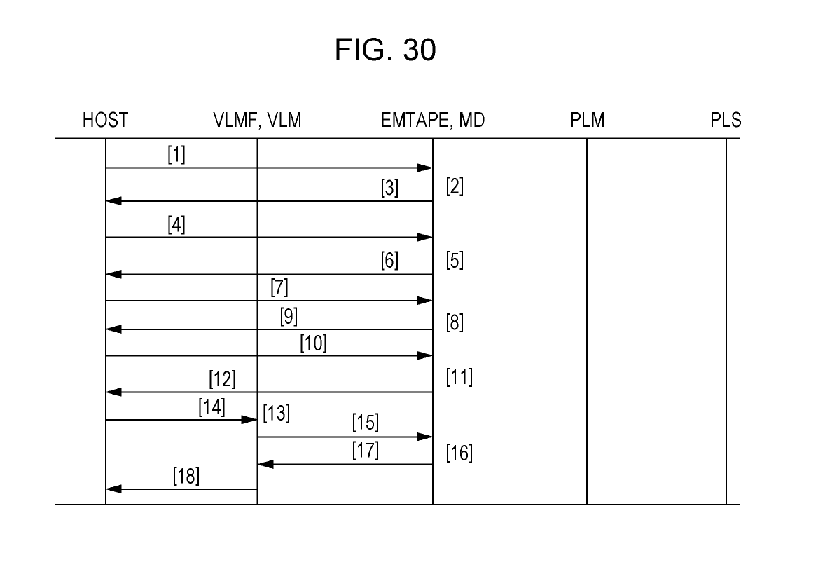

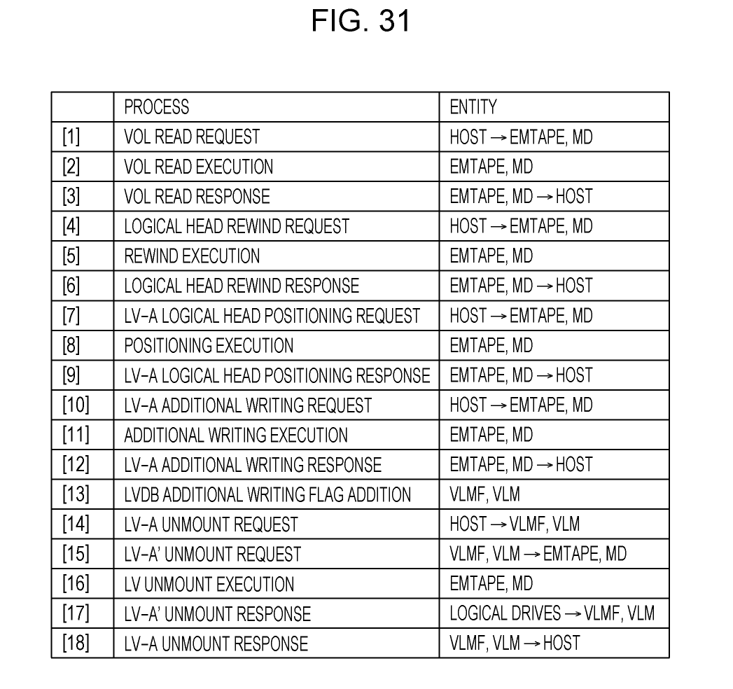

With reference to FIG. 30 and FIG. 31, in accordance with a flowchart illustrated in FIG. 29 (steps B1 through B16), additional write process to an LV-A′ in the virtual library system 1 as one example of embodiments is described. FIG. 30 is a sequence diagram illustrating additional write process in the virtual library system 1 as one example of embodiments, and FIG. 31 illustrates each process in FIG. 30 and entities thereof.

In write process of additional writing to an LV-A′, in step B1, the host 200 carries out a request of VOL Read to the EMTAPE 151 and the MD 152 (refer to code [1] in FIG. 30 and FIG. 31). Here, VOL Read is process that loads a volume block (VOL) and is carried out to confirm whether or not an LV is an instruction from the host 200. The volume block is a block of 80 bytes in which information, such as a volume name and an owner, is written. In general, VOL Read is executed when data is written in the LV or when data of the LV is loaded.

In step B2, when the EMTAPE 151 and the MD 152 execute VOL Read (refer to code [2] in FIG. 30 and FIG. 31), a response of VOL Read from the EMTAPE 151 and the MD 152 to the host 200 is carried out in step B3 (refer to code [3] in FIG. 30 and FIG. 31).

After that, a request to rewind a logical head is issued from the host 200 to the EMTAPE 151 and the MD 152, and the EMTAPE 151 and the MD 152 accept the rewind request in step B4 (refer to code [4] in FIG. 30 and FIG. 31). In step B5, the EMTAPE 151 and the MD 152 rewind the logical head to a leader side of the LV-A′ (refer to code [5] in FIG. 30 and FIG. 31). After that, in step B6, the EMTAPE 151 and the MD 152 notify the host 200 of a response of rewind completion of the logical head (refer to code [6] in FIG. 30 and FIG. 31).

When the host 200 issues a request to position the logical head to the EMTAPE 151 and the MD 152 (refer to code [7] in FIG. 30 and FIG. 31), the EMTAPE 151 and the MD 152 accept this positioning request in step B7.

The EMTAPE 151 and the MD 152 execute positioning of the logical head to the LV-A′ (refer to code [8] in FIG. 30 and FIG. 31). On this occasion, the command to position the logical head issued from the host 200 is a positioning command to the LV-A′. Accordingly, the substitution logical volume control unit 13 inhibits execution of the issued positioning command and skips the process (step B8). In step B9, a response of completion of positioning the logical head is carried out from the EMTAPE 151 and the MD 152 to the host 200 (refer to code [9] in FIG. 30 and FIG. 31).

After that, the host 200 carries out an additional writing request of the LV-A′ to the EMTAPE 151 and the MD 152 (refer to code [10] in FIG. 30 and FIG. 31). The EMTAPE 151 and the MD 152 accept the additional writing request (step B10) for execution (step B11; refer to code [11] in FIG. 30 and FIG. 31).

In step B12, the EMTAPE 151 and the MD 152 carry out a response of LV-A additional writing completion to the host 200 (refer to code [12] in FIG. 30 and FIG. 31). In step B13, the VLMF 111 and the VLM 112 load a flag of additional writing on the substitution flag in the LV information of the LV-A′ of the LV management information 21 (refer to code [13] in FIG. 30 and FIG. 31).

When the host 200 issues an unmount request of an LV-A to the VLMF 111 and the VLM 112 (refer to code [14] in FIG. 30 and FIG. 31), the VLMF 111 and the VLM 112 accept the LV-A unmount request in step B14.

The VLMF 111 and the VLM 112 issue an unmount request of the LV-A to the EMTAPE 151 and the MD 152 (refer to code [15] in FIG. 30 and FIG. 31), and the EMTAPE 151 and the MD 152 execute unmount of the LV-A′ in step B15 (refer to code [16] in FIG. 30 and FIG. 31).

The EMTAPE 151 and the MD 152 notify the VLMF 111 and the VLM 112 of an unmount response of the LV-A′ (refer to code [17] in FIG. 30 and FIG. 31), and the VLMF 111 and the VLM 112 notify the host 200 of the LV-A unmount completion response (refer to code [18] in FIG. 30 and FIG. 31) to terminate the process.

(B-2) Rewrite Process

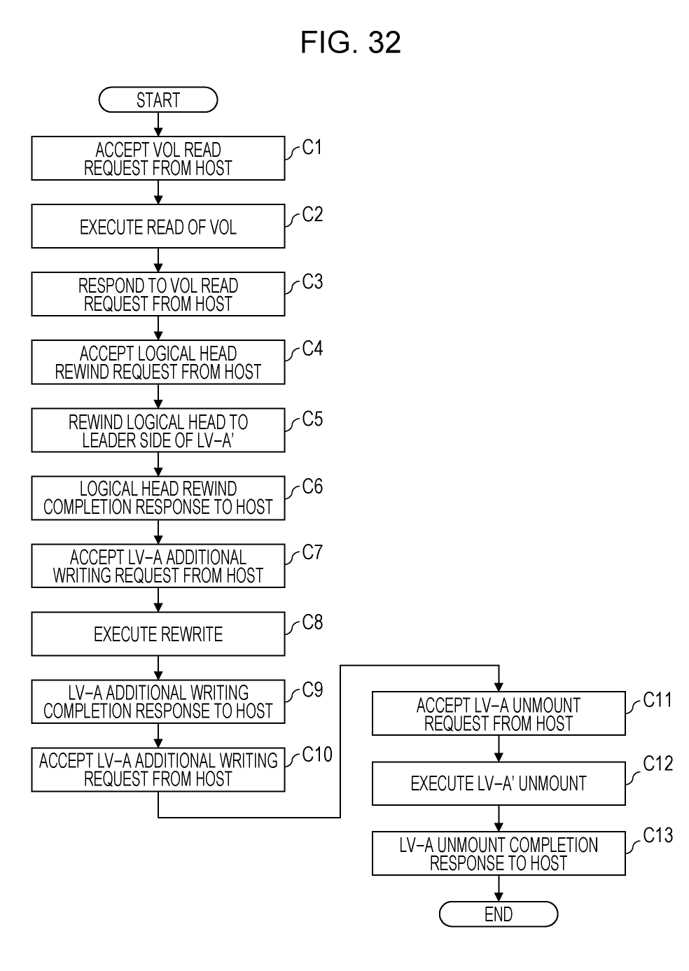

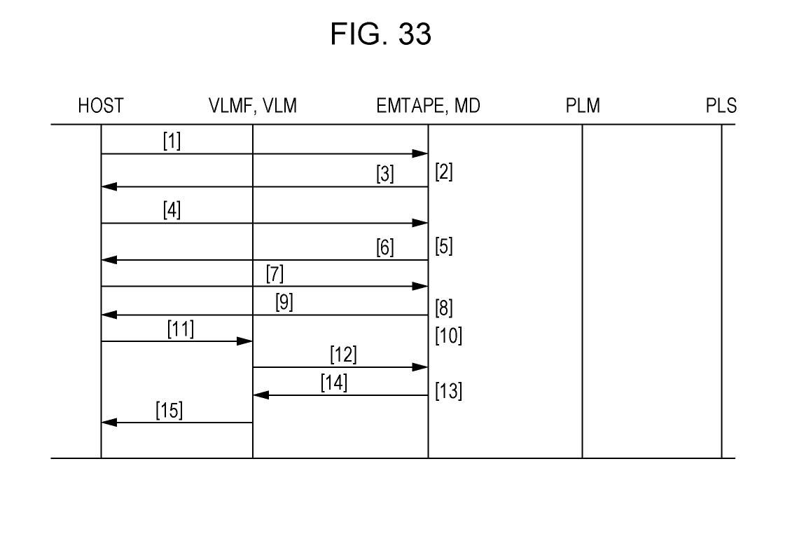

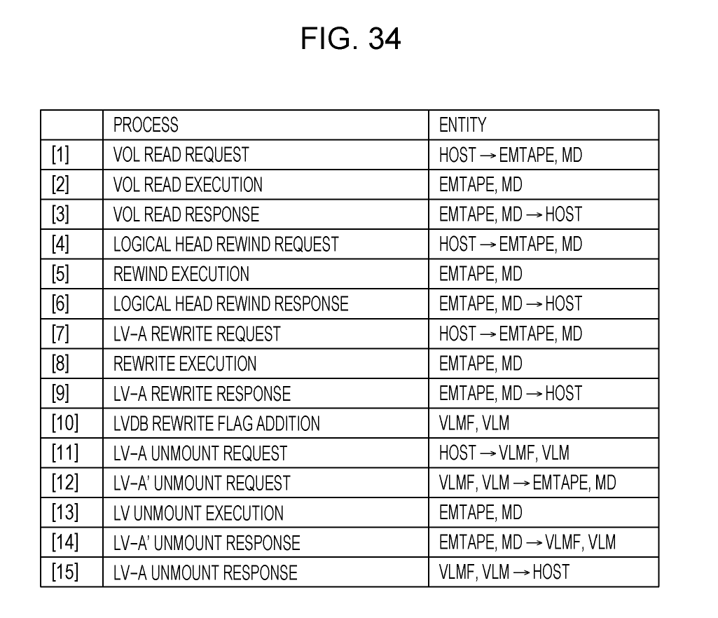

With reference to FIG. 33 and FIG. 34, in accordance with a flowchart illustrated in FIG. 32 (steps C1 through C13), descriptions are given to rewrite process to an LV-A′ in the virtual library system 1 as one example of embodiments. FIG. 33 is a sequence diagram illustrating additional write process in the virtual library system 1 as one example of embodiments, and FIG. 34 illustrates each process in FIG. 33 and entities thereof.

In write process of rewrite to an LV-A′, in step C1, the host 200 carries out a request of VOL Read to the EMTAPE 151 and the MD 152 (refer to code [1] in FIG. 33 and FIG. 34).

When the EMTAPE 151 and the MD 152 execute VOL Read in step C2 (refer to code [2] in FIG. 33 and FIG. 34), a response of VOL Read is carried out from the EMTAPE 151 and the MD 152 to the host 200 (refer to code [3] in FIG. 33 and FIG. 34).

After that, a request to rewind a logical head is issued from the host 200 to the EMTAPE 151 and the MD 152, and the EMTAPE 151 and the MD 152 accept this rewind request in step C4 (refer to code [4] in FIG. 33 and FIG. 34). In step C5, the EMTAPE 151 and the MD 152 rewind the logical head to a leader side of the LV-A′ (refer to code [5] in FIG. 33 and FIG. 34). After that, in step C6, the EMTAPE 151 and the MD 152 notify the host 200 of a response of rewind completion of the logical head (refer to code [6] in FIG. 33 and FIG. 34).

When the host 200 issues a request to rewrite the LV-A to the EMTAPE 151 and the MD 152 (refer to code [7] in FIG. 33 and FIG. 34), the EMTAPE 151 and the MD 152 accept the request to rewrite the LV-A in step C7.

In step C8, the EMTAPE 151 and the MD 152 execute rewrite of the LV-A (refer to code [8] in FIG. 33 and FIG. 34). In step C9, the EMTAPE 151 and the MD 152 carry out a response of completion of the LV-A rewrite to the host 200 (refer to code [9] in FIG. 33 and FIG. 34). In step C10, the VLMF 111 and the VLM 112 add a flag of rewrite to the substitution flag in the LV information of the LV-A′ of the LV management information 21 (refer to code [10] in FIG. 33 and FIG. 34).

When the host 200 issues an unmount request of the LV-A to the VLMF 111 and the VLM 112 (refer to code [11] in FIG. 33 and FIG. 34), the VLMF 111 and the VLM 112 accept the LV-A unmount request in step C11.

The VLMF 111 and the VLM 112 issue an unmount request of an LV-A′ to the EMTAPE 151 and the MD 152 (refer to code [12] in FIG. 33 and FIG. 34), the EMTAPE 151 and the MD 152 execute unmount of the LV-A′ in step C12 (refer to code [13] in FIG. 33 and FIG. 34).

The EMTAPE 151 and the MD 152 notify the VLMF 111 and the VLM 112 of an unmount response of the LV-A′ (refer to code [14] in FIG. 33 and FIG. 34), and the VLMF 111 and the VLM 112 notify the host 200 of the LV-A unmount completion response in step C13 (refer to code [15] in FIG. 33 and FIG. 34) to terminate the process.

(C) Migration Process

As described before, in the present virtual library system 1, when data update occurs in an LV in the cache disk 160, the substitution logical volume control unit 13 (migration process unit) migrates the LV to a cartridge tape in the actual library device 300.

(C-1) Migration of Additional Write Process

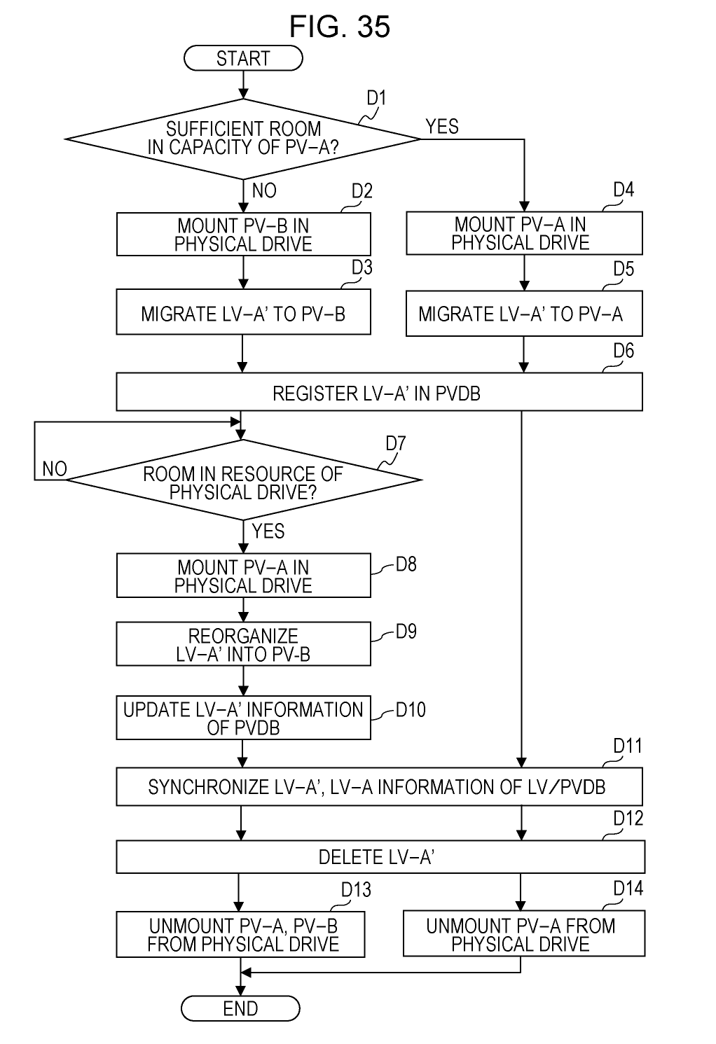

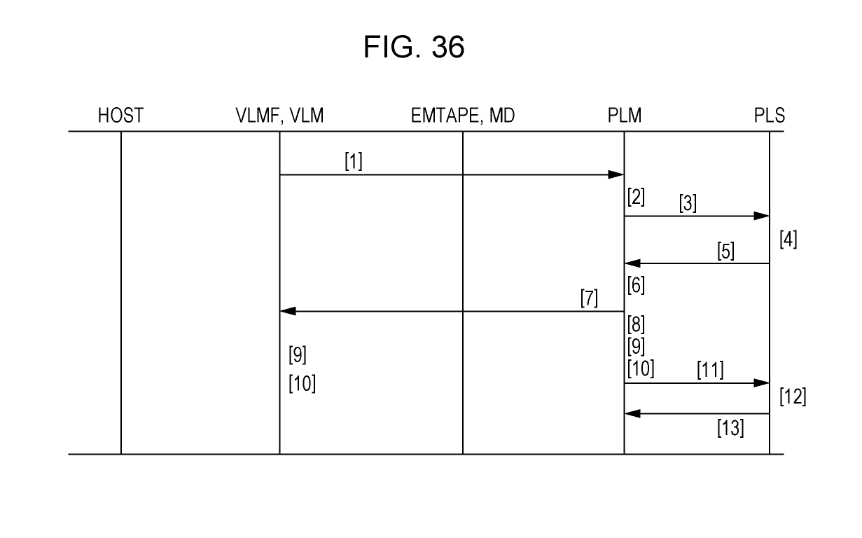

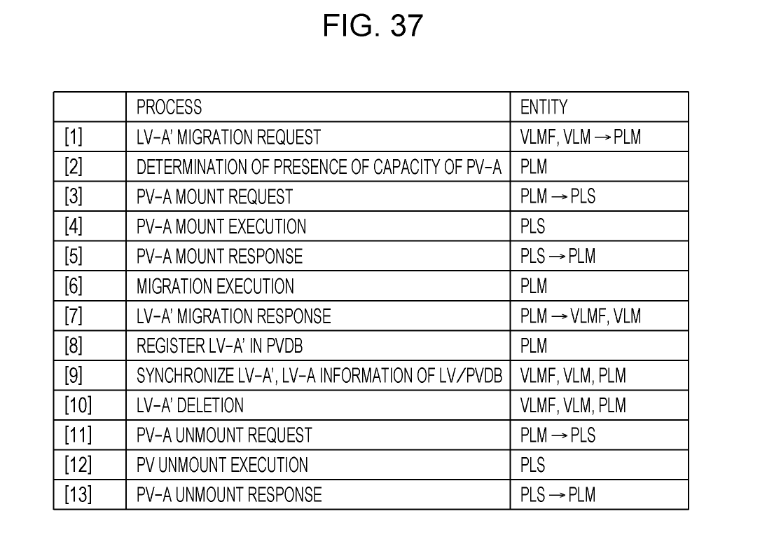

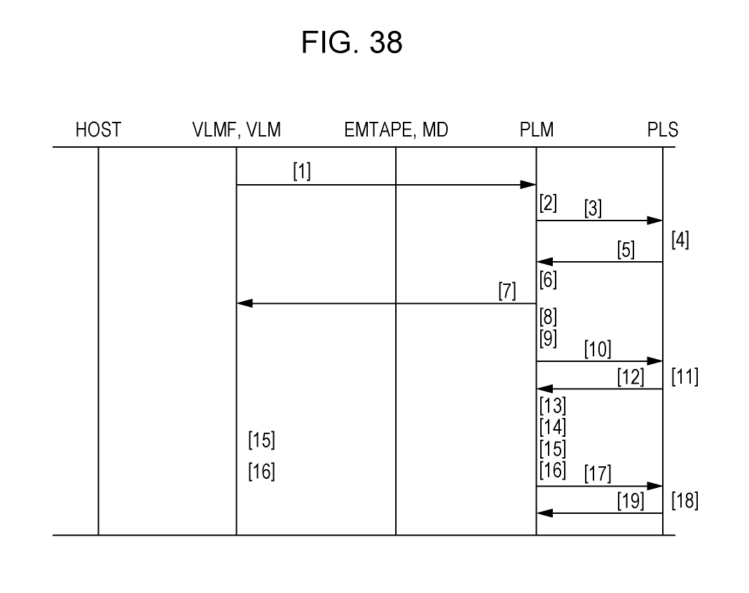

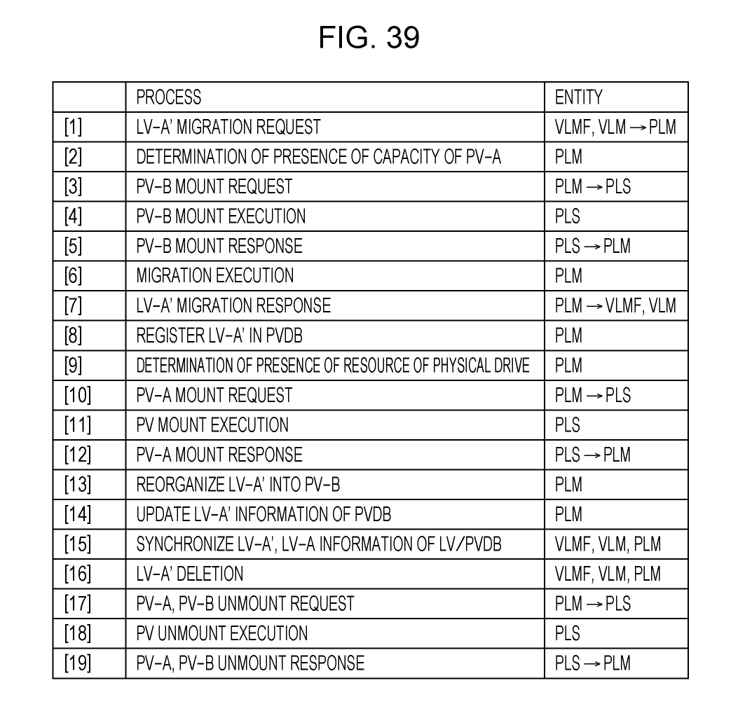

With reference to FIG. 36 through FIG. 39, in accordance with a flowchart illustrated in FIG. 35 (steps D1 through D14), descriptions are given to migration process in a case of additional writing in the virtual library system 1 as one example of embodiments. FIG. 36 is a sequence diagram illustrating additional write process in migration to an identical PV in the virtual library system 1 as one example of embodiments, and FIG. 37 illustrates each process in FIG. 36 and entities thereof. FIG. 38 is a sequence diagram illustrating additional write process in division migration in the virtual library system 1 as one example of embodiments, and FIG. 39 illustrates each process in FIG. 38 and entities thereof. In other words, FIG. 38 and FIG. 39 illustrate a case that a substitution logical volume is not migrated to an identical PV.

First, the VLMF 111 and the VLM 112 carry out a request of LV-A′ migration to the PLM 113 (refer to code [1] in FIG. 36 through FIG. 39).

In step D1, the PLM 113 confirms whether or not a PV-A has a sufficient free space to store data of an LV-A′ (refer to code [2] in FIG. 36 through FIG. 39).

In a case that the PV-A has sufficient room (refer to YES route in step D1), the PLM 113 carries out a request to mount the PV-A in the physical drive 310 to the PLS 114 (refer to code [3] in FIG. 36 and FIG. 37). In step D4, the PLS 114 mounts the PV-A in the physical drive 310 (refer to code [4] in FIG. 36 and FIG. 37). The PLS 114 responds to the PLM 113 with the mount of the PV-A (refer to code [5] in FIG. 36 and FIG. 37), and the PLM 113 executes migration of an LV-A′ to the PV-A in step D5 (refer to code [6] in FIG. 36 and FIG. 37). The PLM 113 responds to the VLMF 111 and the VLM 112 with completion of the LV-A′ migration (refer to code [7] in FIG. 36 and FIG. 37).

In contrast, in a case that the PV-A does not have sufficient room (refer to NO route in step D1), the PLM 113 carries out a request to mount the PV-B in the physical drive 310 to the PLS 114 (refer to code [3] in FIG. 38 and FIG. 39). In step D2, the PLS 114 mounts the PV-B in the physical drive 310 (refer to code [4] in FIG. 38 and FIG. 39). The PLS 114 responds to the PLM 113 with the mount of the PV-B (refer to code [5] in FIG. 38 and FIG. 39), and the PLM 113 executes migration (division migration) of an LV-A′ to the PV-B in step D3 (refer to code [6] in FIG. 38 and FIG. 39). The PLM 113 responds to the VLMF 111 and the VLM 112 with the completion of the LV-A′ migration (refer to code [7] in FIG. 38 and FIG. 39).

When the migration is completed, the PLM 113 registers LV-A′ information in the PV management information 22 by taking the already registered LV-A information into account in step D6 (refer to code [8] in FIG. 38 and FIG. 39).

Here, in a case that the LV-A′ is migrated to the PV-B, in other words, in a case that division migration is carried out, reorganization process related to division migration illustrated in steps D7 through D9 below is carried out.

In other words, in step D7, confirmation of whether or not there is room in the resource of the physical drive 310 is carried out (refer to code [9] in FIG. 38 and FIG. 39). In a case that there is no room in the resource of the physical drive 310 (refer to NO route in step D7), step D7 is carried out repeatedly.

In a case that there is room in the resource of the physical drive 310 (refer to YES route in step D7), the PLM 113 carries out a request to mount the PV-A in the physical drive 310 to the PLS 114 (refer to code [10] in FIG. 38 and FIG. 39).

In step D8, the PLS 114 mounts the PV-A in the physical drive 310 (refer to code [11] in FIG. 38 and FIG. 39). The PLS 114 responds to the PLM 113 with the mount of the PV-A (refer to code [12] in FIG. 38 and FIG. 39) and reorganizes the LV-A′ to the PV-B in step D9 (refer to code [13] in FIG. 38 and FIG. 39). In step D10, the LV-A′ information in the PV management information 22 is updated (refer to code [14] in FIG. 38 and FIG. 39).

After that, in step D11, the PLM 113 synchronizes the LV-A information in the PV management information 22 with the LV-A′ information. The VLMF 111 and the VLM 112 synchronizes the LV-A information in the LV management information 21 with the LV-A′ information (refer to code [9] in FIG. 36 and FIG. 37, and code [15] in FIG. 38 and FIG. 39).

In step D12, the PLM 113 deletes the LV-A′ information from the PV management information 22, and the VLMF 111 and the VLM 112 does from the LV management information 21 and the cache disk 160 (refer to code [10] in FIG. 36 and FIG. 37, and code [16] in FIG. 38 and FIG. 39).

The PLM 113 carries out an unmount request of a PV-A or a PV-B to the PLS 114 (refer to code [11] in FIG. 36 and FIG. 37, and code [17] in FIG. 38 and FIG. 39). In other words, in a case that migration to the PV-A is carried out, the PLS 114 unmounts the PV-A in step D14 (refer to code [12] in FIG. 36 and FIG. 37). In contrast, in a case that migration to the PV-B is carried out, the PLS 114 unmounts the PV-A and the PV-B in step D13 (refer to code [18] in FIG. 38 and FIG. 39).

The PLS 114 carries out a response of unmount completion to the PLM 113 (refer to code [13] in FIG. 36 and FIG. 37, and code [19] in FIG. 38 and FIG. 39) to terminate the process.

(C-2) Case of Rewrite Process

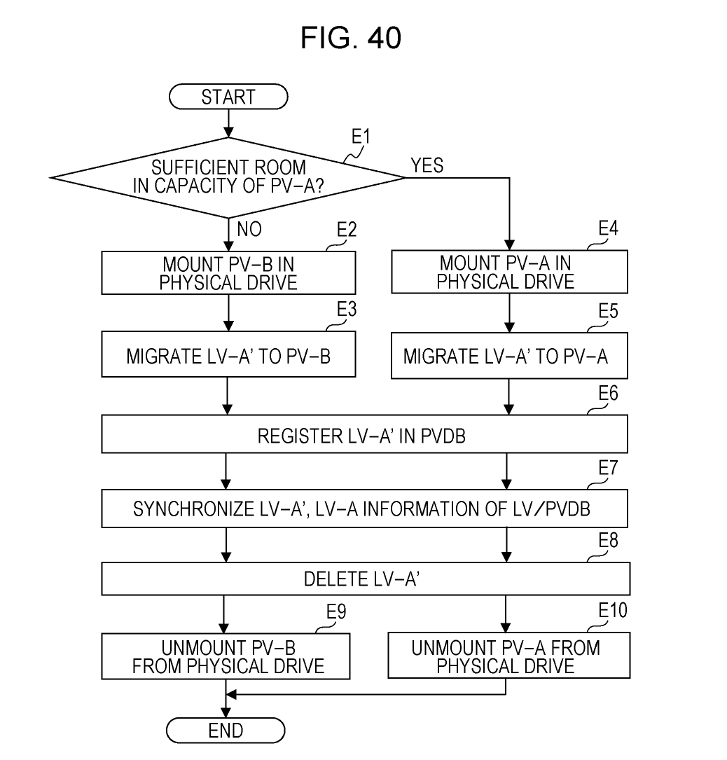

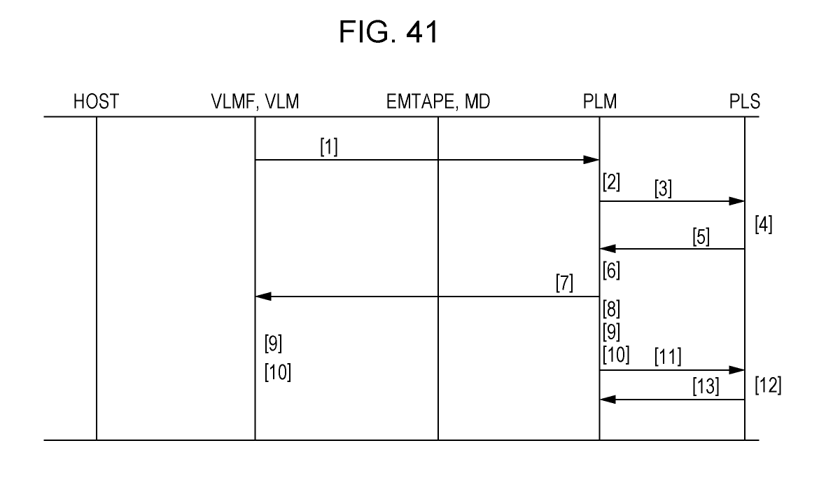

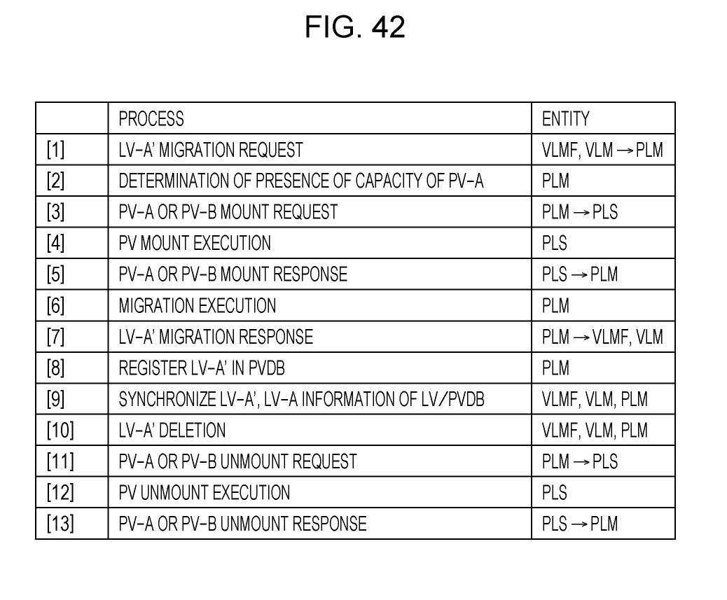

With reference to FIG. 41 and FIG. 42, in accordance with a flowchart illustrated in FIG. 40 (steps E1 through E10), descriptions are given to migration process in a case of rewrite in the virtual library system 1 as one example of embodiments. FIG. 41 is a sequence diagram illustrating migration according to rewrite process in the virtual library system 1 as one example of embodiments, and FIG. 42 illustrates each process in FIG. 41 and entities thereof.

First, the VLMF 111 and the VLM 112 carry out a request of LV-A′ migration from to the PLM 113 (refer to code [1] in FIG. 41 and FIG. 42).

In step E1, the PLM 113 confirms whether or not the PV-A has a sufficient free space to store data of an LV-A′ (refer to code [2] in FIG. 41 and FIG. 42).

In a case that there is sufficient room in the PV-A (refer to YES route in step E1), the PLM 113 carries out a request to mount the PV-A in the physical drive 310 to the PLS 114 (refer to code [3] in FIG. 41 and FIG. 42). In step E4, the PLS 114 mounts the PV-A in the physical drive 310 (refer to code [4] in FIG. 41 and FIG. 42). The PLS 114 responds to the PLM 113 with the mount of the PV-A (refer to code [5] in FIG. 41 and FIG. 42), the PLM 113 executes migration of an LV-A′ to the PV-A in step E5 (refer to code [6] in FIG. 41 and FIG. 42). The PLM 113 responds to the VLMF 111 and the VLM 112 with the completion of the LV-A′ migration (refer to code [7] in FIG. 41 and FIG. 42).

In contrast, in a case that there is no sufficient room in the PV-A (refer to NO route in step E1), the PLM 113 carries out a request to mount the PV-B in the physical drives 310 to the PLS 114 (refer to code [3] in FIG. 41 and FIG. 42). In step E2, the PLS 114 mounts the PV-B in the physical drive 310 (refer to code [4] in FIG. 41 and FIG. 42). The PLS 114 responds to the PLM 113 with the mount of the PV-B (refer to code [5] in FIG. 41 and FIG. 42) and the PLM 113 executes migration of the LV-A′ to the PV-B (refer to code [6] in FIG. 41 and FIG. 42). The PLM 113 responds to the VLMF 111 and the VLM 112 with the completion of the LV-A′ migration (refer to code [7] in FIG. 41 and FIG. 42).

When the migration is completed, the PLM 113 registers the LV-A′ information in the PV management information 22 in step E6 (refer to code [8] in FIG. 41 and FIG. 42). At this time, the data of the LV-A that is already stored in the PV-A becomes invalid (refer to FIG. 22).

In step E7, the PLM 113 synchronizes the LV-A information in the PV management information 22 (refer to FIG. 22) with the LV-A′ information (refer to FIG. 23). The VLMF 111 and the VLM 112 synchronizes the LV-A information in the LV management information 21 (refer to FIG. 4) with the LV-A′ information (refer to FIG. 12) (refer to code [9] in FIG. 41 and FIG. 42).

In step E8, the PLM 113 deletes the LV-A′ information from the PV management information 22, and the VLMF 111 and the VLM 112 deletes the LV-A′ information from the LV management information 21 and the cache disk 160 (refer to code [10] in FIG. 41 and FIG. 42).

The PLM 113 carries out an unmount request of a PV-A or a PV-B to the PLS 114 (refer to code [11] in FIG. 41 and FIG. 42). In other words, in a case that migration to the PV-A is carried out, the PLS 114 unmounts the PV-A in step E10 (refer to code [12] in FIG. 41 and FIG. 42). In contrast, in a case that migration to the PV-B is carried out, the PLS 114 unmounts the PV-B in step E9 (refer to code [12] in FIG. 41 and FIG. 42).

The PLS 114 carries out a response of unmount completion to the PLM 113 (refer to code [13] in FIG. 41 and FIG. 42) to terminate the process.

(3) Regarding Read Process

For reference, descriptions are given to a read request from the host 200 in the present virtual library system 1.

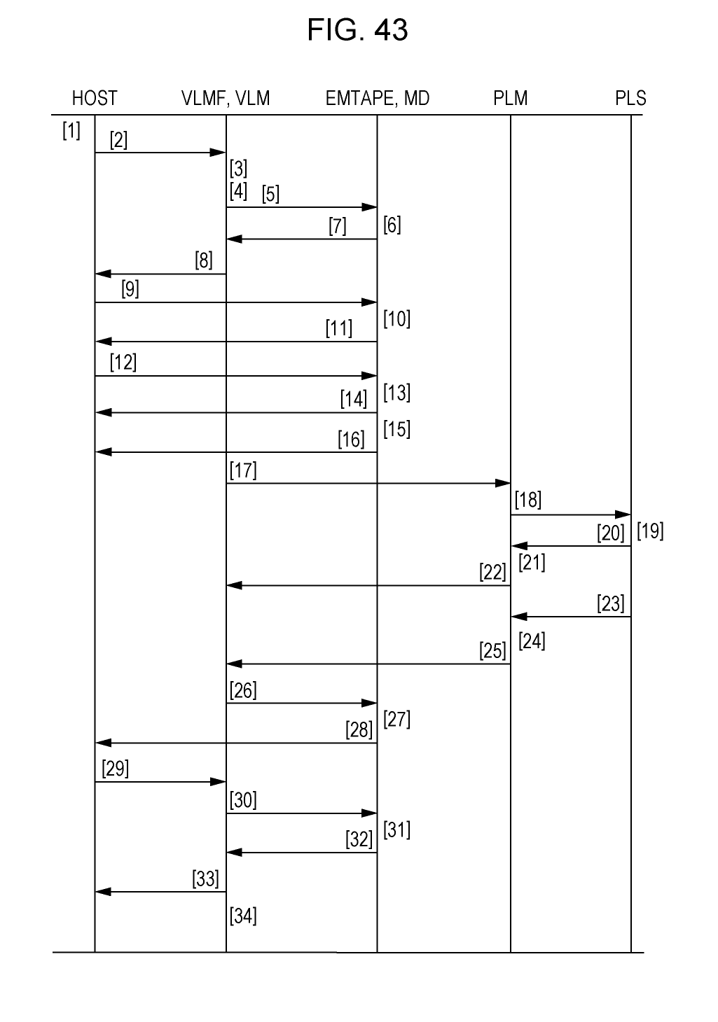

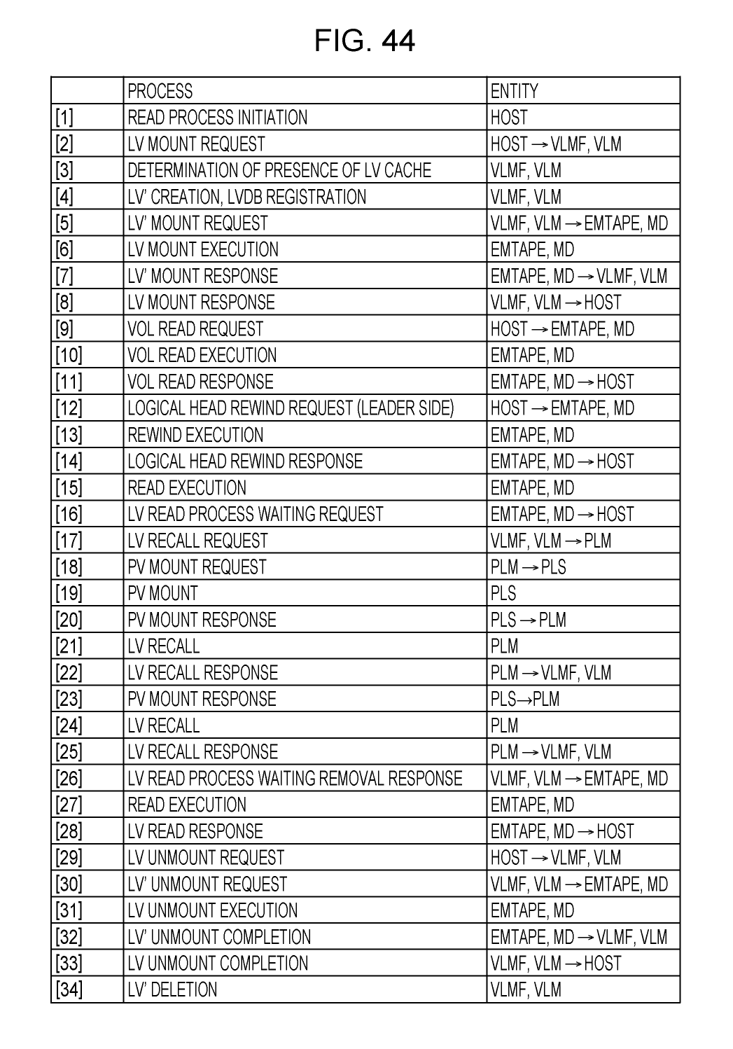

The timing that the virtual storage device 100 understands the process from the host 200 as read is when the read is executed, in other words, when the read command is accepted from the host 200 (refer to code [15] in FIG. 43 and FIG. 44 described later).

At this time, in a case that a substance of the LV data subject to read is not present in the cache disk 160, in other words, there is only stub data, the virtual storage device 100 temporarily keeps execution of read by the host 200 waiting until the LV data is recalled in the cache disk 160.

A destination to recall the LV data is defined as the LV. Taking the recall completion as an opportunity, the host restarts the read process.

As described before, due to the properties as a backup device, the virtual library system 1 makes a predominantly great number of write process and a less number of read process. For this tendency, there is a low possibility that the host 200 reads an LV that is recently recalled in the near future immediately. That an LV not present in the cache disk 160 is present signifies that the capacity of the cache disk 160 is full. In order to respond to a further write request from the host 200, it is advantageous for administration to increase a free space in the cache disk 160 as much as possible. In the present virtual library system 1, as soon as the read is completed, the LV′ containing the LV data that is recalled immediately before is deleted.

In a case of intending to intentionally expand LV data not present in the cache disk 160 over the cache disk 160, it is desirable to execute preload of an established function.

With reference to FIG. 44, descriptions are given to read process to a substitution logical volume in the virtual library system 1 as one example of embodiments in accordance with a sequence diagram illustrated in FIG. 43. FIG. 44 illustrates each process in FIG. 43 and entities thereof.

The host 200 carries out, after initiating read process to the EMTAPE 151 and the MD 152 (refer to code [1]), a request from to mount an LV to the VLMF 111 and the VLM 112 (refer to code [2]). The VLMF 111 and the VLM 112 determines whether or not the LV subjected to the read request is in the cache disk 160 (refer to code [3]).

In a case that the LV subjected to the read request is not in the cache disk 160, the VLMF 111 and the VLM 112 create an LV′ and register this LV′ in the LV management information 21 (refer to code [4]). The VLMF 111 and the VLM 112 request mount of the LV′ to the EMTAPE 151 and the MD 152 (refer to code [5]). The EMTAPE 151 and the MD 152 execute the mount of the LV′ (refer to code [6]) and carry out a response to the VLMF 111 and the VLM 112 that the mount of the LV′ is completed (refer to code [7]).

The VLMF 111 and the VLM 112 carry out a response to the host 200 that the mount of the LV subjected to read is completed (refer to code [8]).

After carrying out a request to load a VOL to the EMTAPE 151 and the MD 152 (refer to code [9]), the host 200 executes read (refer to code [10]), and the EMTAPE 151 and the MD 152 carry out a response of VOL load to the host 200 (refer to code [11]).

The host 200 carries out a rewind request to the EMTAPE 151 and the MD 152 to a leader side of the logical head (refer to code [12]). The EMTAPE 151 and the MD 152 accordingly carry out rewind of the logical head (refer to code [13]), and carry out a response to the host 200 that the rewind is carried out (refer to code [14]).

Then, the host 200 executes read (refer to code [15]). The VLMF 111 and the VLM 112 request waiting for execution of read process to the host 200 (refer to code [16]). In other words, execution of read by the host 200 is temporarily kept waiting (inhibited) until LV data subject to read out is recalled in the cache disk 160.

The VLMF 111 and the VLM 112 carry out a recall request of the LV subject to read to the PLM 113 (refer to code [17]), and the PLM 113 carries out a request to mount a PV in which the LV subject to read is stored to the PLS 114 (refer to code [18]).

The PLS 114 executes mount of the PV (refer to code [19]) and carries out a response to the PLM 113 that the mount is completed (refer to code [20]).

The PLM 113 carries out recall of the PV in which the LV subject to read is stored (refer to code [21]). The PLM 113 carries out a response of LV recall to the VLMF 111 and the VLM 112 (refer to code [22]). The PLS 114 carries out a response of PV mount to the PLM 113 (refer to code [23]).

After carrying out recall of the LV-A (refer to code [24]), the PLM 113 carries out a response of LV-A recall to the VLMF 111 and the VLM 112 (refer to code [25]). The VLMF 111 and the VLM 112 carry out a response to the host 200 of removal of the read process waiting (refer to code [26]). Taking the recall completion as an opportunity, the host 200 executes (restarts) the read (refer to code [27]), and the EMTAPE 151 and the MD 152 carry out a response of LV read to the host 200 (refer to code [28]).

When the host 200 requests unmount of the LV to the VLMF 111 and the VLM 112 (refer to code [29]), the VLMF 111 and the VLM 112 carry out the unmount request of the LV to the EMTAPE 151 and the MD 152 (refer to code [30]).

The EMTAPE 151 and the MD 152 execute the unmount of the LV (refer to code [31]) and notify the VLMF 111 and the VLM 112 of LV unmount completion (refer to code [32]). The VLMF 111 and the VLM 112 notify the host 200 of the LV unmount completion (refer to code [33]) and delete the LV (refer to code [34]).

(4) Effects

In such a manner, according to the virtual library system 1 as one example of embodiments, in a case that a write request is made from the host 200 to an LV not present in the cache disk 160, the substitution logical volume creation unit 12 creates an LV′. Then, the substitution logical volume control unit 13 carries out the write request from the host 200 to this LV′. This causes the PV in which the requested LV is stored not to have to be mounted in the tape drive (physical drive) 310 and enables to omit the recall process including a mechanical behavior of the robot 312 in the actual library device 300. Accordingly, in a case that a write request is made from the host 200 to an LV not present in the cache disk 160, it is possible to process this write request in a short time period and to improve the writing performances of the virtual storage device 100.

In a case that it is difficult to store a space for the LV′ in the cache disk 160, in accordance with an LRU algorithm, an LV that is not referred to in a long time period is removed from the cache disk 160 to secure the space for the LV′. This enables to securely create an LV′ in the cache disk 160.

In addition, the substitution logical volume creation unit 12 creates an LV′ using stub of the LV, thereby enabling easy creation of LV′, which is highly convenient.

In a case that a write request to an LV′ is carried out from the host 200, and in a case that the write request is additional write process, the substitution logical volume control unit 13 carries out data write from the start of an LV′ by inhibiting execution of a positioning command that is accompanied by the write request. This enables to achieve additional write process to the LV′.

In contrast, in a case that a write request to an LV′ is carried out, and in a case that the write request is rewrite process, the substitution logical volume control unit 13 writes data in the LV′ immediately.

In such a manner, it is possible to handle a write request to an LV′ either of additional write process or rewrite process.

After migrating data of the LV′ to the PV, the substitution logical volume control unit (substitution logical volume deletion unit) 13 deletes the migrated PV′ from the cache disk 160. This enables to secure a free space in the cache disk 160 and to use efficiently.

In addition, collecting the LV division migrated to a plurality of PVs by reorganization to carry out remigration as one data item enables to shorten the time period taken for recall of the LV.

(5) Others

Then, the disclosed technique is not limited to the embodiments described above and may be performed in a variety of modifications without departing from the spirit of the present embodiments. Each configuration and each process of the present embodiments may be selected depending on the preference or may also be combined appropriately.

Still in addition, the present embodiments disclosed above may be performed and manufactured by those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A virtual library controller comprising:
a substitution logical volume creation unit to create, in a case that a logical volume subject to an instruction to write data from a superior device is not present in a cache disk, a substitution logical volume in the cache disk; and
a write process unit to carry out write of the data in the created substitution logical volume.

2. The virtual library controller according to claim 1, wherein
the substitution logical volume creation unit creates the substitution logical volume by copying management information in the cache disk for the logical volume subject to the write instruction.

3. The virtual library controller according to claim 1, wherein
the substitution logical volume creation unit sets identification information that indicates a state of substitution to the substitution logical volume in management information to manage a logical volume.

4. The virtual library controller according to claim 1, wherein
the substitution logical volume creation unit deletes, in a case that there is no free space to allow storage of the substitution logical volume in the cache disk, a logical volume that is equivalent to capacity allowing storage of the substitution logical volume from the cache disk.

5. The virtual library controller according to claim 4, wherein
the substitution logical volume creation unit selects, out of logical volumes in the cache disk, the logical volume with low frequency of access with a priority as a logical volume to be deleted from the cache disk.

6. The virtual library controller according to claim 1, wherein
the write process unit carries out, in a case that the write instruction from the superior device is additional write process, write from a start of the substitution logical volume by inhibiting execution of a positioning command accompanied by the write instruction.

7. The virtual library controller according to claim 1, further comprising:
a substitution logical volume deletion unit to delete, after moving data in the logical volume to a physical volume, the substitution logical volume from the cache disk.

8. The virtual library controller according to claim 1, further comprising:
a coupling process unit to couple, in a case that a plurality of the logical volumes related with each other are moved to a plurality of physical volumes, the logical volumes that are read out respectively of the plurality of physical volumes in the cache disk and to move the coupled plurality of logical volumes to an identical physical volume.

9. A method of controlling a virtual library controller that mediates between a superior device and an actual library device and causes a logical volume to be stored in a cache disk as a virtual library device, the method comprising:
creating, in a case that a logical volume subject to an instruction to write data from the superior device is not present in the cache disk, a substitution logical volume in the cache disk; and
carrying out write of the data in the created substitution logical volume.

10. The control method according to claim 9, wherein
the substitution logical volume is created by copying management information in the cache disk for the logical volume subject to the write instruction.

11. The control method according to claim 9, wherein
identification information that indicates a state of substitution to the substitution logical volume is set in management information to manage a logical volume.

12. The control method according to claim 9, wherein
a logical volume that is equivalent to capacity allowing storage of the substitution logical volume, in a case that there is no free space to allow storage of the substitution logical volume in the cache disk, is deleted from the cache disk.

13. The control method according to claim 12, wherein
the logical volume with low frequency of access with a priority, out of logical volumes in the cache disk, is selected as the logical volume to be deleted from the cache disk.

14. The control method according to claim 9, wherein
write is carried out from a start of the substitution logical volume, in a case that the write instruction from the superior device is additional write process, by inhibiting execution of a positioning command accompanied by the write instruction.

15. The control method according to claim 9, further comprising:
deleting, after moving data in the substitution logical volume to a physical volume, the substitution logical volume from the cache disk.

16. The control method according to claim 9, further comprising:
coupling, in a case that a plurality of the logical volumes related with each other are moved to a plurality of physical volumes, the logical volumes that are read out respectively of the plurality of physical volumes in the cache disk and to move the coupled plurality of logical volumes to an identical physical volume.
